(19) United States
(12) Patent Application Publication
(10) Pub. No.: US 2024/0402342 A1
(43) Pub. Date: Dec. 5, 2024

(54) EXTENDED MATERIAL DETECTION INVOLVING A MULTI WAVELENGTH PROJECTOR

(71) Applicant: TRINAMIX GMBH, Ludwigshafen am Rhein (DE)

(72) Inventors: Stephan KNAPP, Ludwigshafen am Rhein (DE); Patrick SCHINDLER, Ludwigshafen am Rhein (DE)

(21) Appl. No.: 18/694,722

(22) PCT Filed: Oct. 25, 2022
(86) PCT No.: PCT/EP2022/079722

§ 371 Date: Mar. 22, 2024

(30) Foreign Application Priority Data
Oct. 26, 2021 (EP) 21204662.7

(51) Int. Cl. G01S 17/89; G01S 7/48; G01S 7/481; G01S 17/46; G06V 10/143; G06V 10/25; G06V 10/764; G06V 10/82; G06V 40/40

(52) U.S. Cl. CPC G01S 17/89; G01S 7/4802; G01S 7/4815; G01S 17/46; G06V 10/143; G06V 40/45; G06V 10/25; G06V 10/765; G06V 10/82

(57) ABSTRACT

A detector for material detection of at least one object is disclosed. The detector includes:
at least one projector for illuminating at least one object with at least one illumination pattern;
at least one flood light source configured for scene illumination;
   at least one sensor element having a matrix of optical sensors,
   and
at least one evaluation device.

### FIELD OF THE INVENTION

The invention relates to a detector for material detection of at least one object, a method for material detection of at least one object and various uses of the detector. The devices, methods and uses according to the present invention specifically may be employed for example in various areas of daily life, security technology, gaming, traffic technology, production technology, photography such as digital photography or video photography for arts, documentation or technical purposes, safety technology, information technology, agriculture, crop protection, maintenance, cosmetics, medical technology or in the sciences. However, other applications are also possible.

### PRIOR ART

Method and devices for material detection are generally known. A reliable technique for material detection uses beam profile analysis as described in WO 2020/187719 the content of which is included by reference.

WO 2020/187719 describes a detector for identifying at least one material property m. The detector comprises at least one sensor element comprising a matrix of optical sensors. The optical sensors each having a light-sensitive area. The sensor element is configured for recording at least one reflection image of a light beam originating from at least one object. The detector comprises at least one evaluation device configured for determining the material property by evaluation of at least one beam profile of the reflection image. The evaluation device is configured for determining at least one distance feature by applying at least one distance dependent image filter to the reflection image.

US 2020/311448 A1 describes a method that includes receiving, at one or more processing devices, data corresponding to a first image, and determining, by the one or more processing devices based on the received data, that a first set of pixel values of the first image corresponds to illumination of a first representative wavelength, and at least a second set of pixel values of the first image corresponds to illumination of a second representative wavelength. The illuminations of the first and second representative wavelengths constitute at least a portion of a first illumination sequence pattern used in capturing the first image. The method also includes determining that the first illumination sequence pattern matches a second illumination sequence pattern associated with a device from which the first image is expected to be received, and in response, initiating a biometric authentication process for authenticating a subject represented in the first image.

US 2017/161557 A9 describes systems, devices, and methods for authenticating an individual or user using biometric features. A system for authenticating a user through identification of at least one biometric feature can include an active light source capable of emitting electromagnetic radiation having a peak emission wavelength at from about 700 nm to about 1200 nm, where the active light source is positioned to emit the electromagnetic radiation to impinge on at least one biometric feature of the user, and an image sensor having infrared light-trapping pixels positioned relative to the active light source to receive and detect the electromagnetic radiation upon reflection from the at least one biometric feature of the user. The system can further include a processing module functionally coupled to the image sensor and operable to generate an electronic representation of the at least one biometric feature of the user from detected electromagnetic radiation, and an authentication module functionally coupled to the processing module that is operable to receive and compare the electronic representation to an authenticated standard of the at least one biometric feature of the user to provide authentication of the user.

However, for difficult targets such as for distinguishing between skin and non-skin objects, e.g. for security application such as unlocking and/or accessing a mobile device, in particular one or more of a television device, a cell phone, a smart phone, a game console, a tablet computer, a personal computer, a laptop, a tablet, a virtual reality device, or another type of portable computer, reliability of the material detection is still a challenge. Specifically, reliable detection of spoofing attacks using very realistic 3D silicon masks is still challenging.

### Problem Addressed by the Invention

It is therefore an object of the present invention to provide devices and methods facing the above-mentioned technical challenges of known devices and methods. Specifically, it is an object of the present invention to provide devices and methods allowing reliable material detection even in case of difficult targets, preferably with a low technical effort and with low requirements in terms of technical resources and cost.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

In a first aspect of the present invention a detector for material detection of at least one object is disclosed.

As used herein, the “detector” generally may refer to a device which is adapted for providing at least one item of information on the material of the at least one object. The detector may be a stationary device or a mobile device. The detector may be a stand-alone device or may form part of another device, such as a computer, a vehicle or any other device. Further, the detector may be a hand-held device. For example, the detector may be a mobile device selected from the group consisting of: a television device, a cell phone, a smart phone, a game console, a tablet computer, a personal computer, a laptop, a tablet, a virtual reality device, or another type of portable computer. Other embodiments of the detector are feasible.

The “object” generally may be an arbitrary object, chosen from a living object and a non-living object. Thus, as an example, the at least one object may comprise one or more articles and/or one or more parts of an article. Additionally or alternatively, the object may be or may comprise one or more living beings and/or one or more parts thereof, such as one or more body parts of a human being, e.g. a user, and/or an animal.

As used herein, the term “material detection” may refer to determining of at least one arbitrary material property characterizing the material of the object. As used herein, the term “material property” refers to at least one arbitrary property of the material configured for characterizing and/or identification and/or classification of the material. For example, the material property may be a property selected from the group consisting of: reflectance, penetration depth of light into the material, roughness, a specular reflectivity, a diffuse reflectivity, a surface property, a measure for translucence, a scattering, specifically a back-scattering behavior or the like. For example, the at least one material property may be a property selected from the group consisting of: a scattering coefficient, a translucency, a transparency, a deviation from a Lambertian surface reflection, a speckle, and the like.

The detector comprises:
at least one projector for illuminating at least one object with at least one illumination pattern, wherein the illumination pattern comprises a plurality of illumination features, wherein the illumination features have a first wavelength;
at least one flood light source configured for scene illumination, wherein the flood light source is configured for emitting the scene illumination having a second wavelength different from the first wavelength;
at least one sensor element having a matrix of optical sensors, the optical sensors each having a light-sensitive area, wherein each optical sensor is designed to generate at least one sensor signal in response to an illumination of its respective light-sensitive area by a light beam propagating from the object to the detector,
wherein the sensor element is configured for imaging at least one reflection image comprising a plurality of reflection features generated by the object in response to the illumination pattern, wherein each of the reflection features comprises a beam profile, wherein the sensor element is configured for imaging at least one scene image of the object illuminated by the scene illumination;
at least one evaluation device,
wherein the evaluation device is configured for determining at least one first material information of the object by evaluating the beam profile of at least one of the reflection features,
wherein the evaluation device is configured for determining at least one second material information of the object by evaluating the scene image, wherein the evaluation device is configured for determining the material of the object using the first material information and the second material information.

As used herein, the term “projector”, also denoted as light projector, may refer to an optical device configured for generating and projecting the at least one illumination pattern onto the object, specifically onto a surface of the object.

As used herein, the term “pattern” may refer to an arbitrary known or pre-determined arrangement comprising a plurality of arbitrarily shaped features such as symbols. The pattern may comprise a plurality of features. The pattern may comprise an arrangement of periodic or non-periodic features. As used herein, the term “at least one illumination pattern” may refer to at least one arbitrary pattern comprising the illumination features adapted to illuminate at least one part of the object.

As used herein, the term “illumination feature” refers to at least one at least partially extended feature of the pattern. The illumination pattern comprises a plurality of illumination features. The illumination pattern may be selected from the group consisting of: at least one point pattern; at least one line pattern; at least one stripe pattern; at least one checkerboard pattern; at least one pattern comprising an arrangement of periodic or non periodic features. The illumination pattern may comprise regular and/or constant and/or periodic pattern such as a triangular pattern, a rectangular pattern, a hexagonal pattern or a pattern comprising further convex tilings. The illumination pattern may exhibit the at least one illumination feature selected from the group consisting of: at least one point; at least one line; at least two lines such as parallel or crossing lines; at least one point and one line; at least one arrangement of periodic or non-periodic feature; at least one arbitrary shaped featured. The illumination pattern may comprise at least one pattern selected from the group consisting of: at least one point pattern, in particular a pseudorandom point pattern; a random point pattern or a quasi random pattern; at least one Sobol pattern; at least one quasiperiodic pattern; at least one pattern comprising at least one pre-known feature at least one regular pattern; at least one triangular pattern; at least one hexagonal pattern; at least one rectangular pattern at least one pattern comprising convex uniform tilings; at least one line pattern comprising at least one line; at least one line pattern comprising at least two lines such as parallel or crossing lines. For example, the projector may be configured for generate and/or to project a cloud of points or non-point-like features. For example, the projector may be configured for generate a cloud of points or non-point-like features such that the illumination pattern may comprise a plurality of point features or non-point-like features. The illumination pattern may comprise regular and/or constant and/or periodic patterns such as a triangular pattern, a rectangular pattern, a hexagonal pattern, or a pattern comprising further convex tilings. The illumination pattern may comprise as many features per area as possible such that a hexagonal pattern may be preferred. A distance between two features of the respective illumination pattern and/or an area of the at least one illumination feature may depend on a circle of confusion in an image determined by at least one detector. For example, illumination pattern may comprise a periodic point pattern.

As further used herein, the term “illuminating with at least one illumination pattern” refers to providing the at least one illumination pattern for illuminating the at least one object. As used herein, the term “ray” generally refers to a line that is perpendicular to wavefronts of light which points in a direction of energy flow. As used herein, the term “beam” generally refers to a collection of rays. In the following, the terms “ray” and “beam” will be used as synonyms. As further used herein, the term “light beam” generally refers to an amount of light, specifically an amount of light traveling essentially in the same direction, including the possibility of the light beam having a spreading angle or widening angle. The light beam may have a spatial extension. Specifically, the light beam may have a non-Gaussian beam profile. The beam profile may be selected from the group consisting of a trapezoid beam profile; a triangle beam profile; a conical beam profile. The trapezoid beam profile may have a plateau region and at least one edge region. The light beam specifically may be a Gaussian light beam or a linear combination of Gaussian light beams, as will be outlined in further detail below. Other embodiments are feasible, however.

Further, the projector may be configured for emitting modulated or non-modulated light. In case a plurality of light sources is used, the different light sources may have different modulation frequencies which later on may be used for distinguishing the light beams.

The projector may comprise at least one array of emitters. The projector may comprise additional elements such as at least one transfer device.

As used herein, the term “emitter” may refer to at least one arbitrary device configured for providing the at least one light beam for illumination of the object. Each of the emitters may be and/or may comprise at least one element selected from the group consisting of at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface-emitting laser (VCSEL), in particular at least one VCSEL-array; at least one non-laser light source such as at least one LED or at least one light bulb.

The array of emitters may be a two-dimensional or one dimensional array. The array may comprise a plurality of emitters arranged in a matrix. As further used herein, the term “matrix” generally may refer to an arrangement of a plurality of elements in a predetermined geometrical order. The matrix specifically may be or may comprise a rectangular matrix having one or more rows and one or more columns. The rows and columns specifically may be arranged in a rectangular fashion. However, other arrangements are feasible, such as nonrectangular arrangements. As an example, circular arrangements are also feasible, wherein the elements are arranged in concentric circles or ellipses about a center point.

For example, the emitters may be an array of VCSELs. As used herein, the term “vertical-cavity surface-emitting laser” refers to a semiconductor laser diode configured for laser beam emission perpendicular with respect to a top surface. Examples for VCSELs can be found e.g. in en.wikipedia.org/wiki/Vertical-cavity_surface-emitting_laser. VCSELs are generally known to the skilled person such as from WO 2017/222618 A. Each of the VCSELs is configured for generating at least one light beam. The VCSELs may be arranged on a common substrate or on different substrates. The array may comprise up to 2500 VCSELs. For example, the array may comprise 38×25 VCSELs, such as a high power array with 3.5 W. For example, the array may comprise 10×27 VCSELs with 2.5 W. For example, the array may comprise 96 VCSELs with 0.9 W. A size of the array, e.g. of 2500 elements, may be up to 2 mm×2 mm.

The illumination features have a first wavelength. The light beam emitted by the respective emitter may have a wavelength of 300 to 1100 nm, preferably 500 to 1100 nm. For example, light in the infrared spectral range may be used, such as in the range of 780 nm to 3.0 μm. Specifically, the light in the part of the near infrared region where silicon photodiodes are applicable specifically in the range of 700 nm to 1100 nm may be used. The emitters may be configured for generating the at least one illumination pattern in the infrared region, in particular in the near infrared region. Using light in the near infrared region may allow that light is not or only weakly detected by human eyes and is still detectable by silicon sensors, in particular standard silicon sensors.

For example, the first wavelength may be 940 nm. This wavelength may be advantageous since terrestrial sun radiation has a local minimum in irradiance at this wavelength, e.g. as described in CIE 085-1989 “Solar spectral Irradiance”. For example, the emitters may be an array of VCSELs. The VCSELs may be configured for emitting light beams at a wavelength range from 800 to 1000 nm. For example, the VCSELs may be configured for emitting light beams at 808 nm, 850 nm, 940 nm, or 980 nm. Preferably the VCSELs emit light at 940 nm.

The projector may comprise the at least one transfer device configured for generating the illumination features from the light beams impinging on the transfer device. The term “transfer device”, also denoted as “transfer system”, may generally refer to one or more optical elements which are adapted to modify the light beam, such as by modifying one or more of a beam parameter of the light beam, a width of the light beam or a direction of the light beam. The transfer device may comprise at least one imaging optical device. The transfer device specifically may comprise one or more of: at least one lens, for example at least one lens selected from the group consisting of at least one focus-tunable lens, at least one aspheric lens, at least one spheric lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system; at least one holographic optical element; at least one meta optical element. Specifically, the transfer device comprises at least one refractive optical lens stack. Thus, the transfer device may comprise a multi-lens system having refractive properties.

The light beam or light beams generated by the projector generally may propagate parallel to the optical axis or tilted with respect to the optical axis, e.g. including an angle with the optical axis. The projector may be configured such that the light beam or light beams propagates from the projector towards the scene along an optical axis. For this purpose, the projector may comprise at least one reflective element, preferably at least one prism, for deflecting the illuminating light beam onto the optical axis. As an example, the light beam or light beams, such as the laser light beam, and the optical axis may include an angle of less than 10°, preferably less than 5° or even less than 2°. Other embodiments, however, are feasible. Further, the light beam or light beams may be on the optical axis or off the optical axis. As an example, the light beam or light beams may be parallel to the optical axis having a distance of less than 10 mm to the optical axis, preferably less than 5 mm to the optical axis or even less than 1 mm to the optical axis or may even coincide with the optical axis.

The term “flood light source” as used herein, is a broad term and is to be given its ordinary and customary meaning to a person of ordinary skill in the art and is not to be limited to a special or customized meaning. The term specifically may refer, without limitation, to at least one arbitrary device adapted to provide the at least one illumination light beam for illumination of the object. The flood light source is configured for scene illumination. As used herein, the term “scene illumination” may refer to diffuse and/or uniform illumination of the scene. As used herein, the term “scene” may refer to at least one arbitrary object or spatial region. The scene may comprise the at least one object and a surrounding environment. The flood light source may be adapted to directly or indirectly illuminating the object, wherein the illumination is reflected or scattered by surfaces of the object and, thereby, is at least partially directed towards the sensor element. The flood light source may be adapted to illuminate the object, for example, by directing a light beam towards the object, which reflects the light beam.

The flood light source is configured for emitting the scene illumination having a second wavelength different from the first wavelength. The flood light source may comprise at least one light-emitting-diode (LED). However, other embodiments are feasible. For example, the flood light source may comprise at least one VCSEL and at least one diffusor as light source. The flood light source may comprise a single light source or a plurality of light sources. As an example, the light emitted by the flood light source may have a wavelength of 300 to 1100 nm, especially 500 to 1100 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1100 nm may be used. The flood light source may be configured for emitting light at a single wavelength. Specifically, the wavelength may be in the near infrared region. In other embodiments, the flood light source may be adapted to emit light with a plurality of wavelengths allowing additional measurements in other wavelengths channels.

The first and the second wavelength may be chosen such that it possible for distinguishing materials. For example, two or more materials may have a similar reflectance for the first wavelength but their respective reflectance for the second wavelength may be different. The first wavelength and the second wavelength may be different wavelength in the infrared spectral range. For example, the first wavelength may be 940 nm and the second wavelength may be 850 nm.

The projector and flood light source may constitute a coordinate system, wherein a longitudinal coordinate is a coordinate along the optical axis. The coordinate system may be a polar coordinate system in which the optical axis forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate z. Any direction perpendicular to the z-axis may be considered a transversal direction, and the polar coordinate and/or the polar angle may be considered a transversal coordinate. As used herein, the term “depth information” may relate to the longitudinal coordinate and/or information from which the longitudinal coordinate can be derived.

As used herein, the term “sensor element” generally refers to a device or a combination of a plurality of devices configured for sensing at least one parameter. In the present case, the parameter specifically may be an optical parameter, and the sensor element specifically may be an optical sensor element. The sensor element may be formed as a unitary, single device or as a combination of several devices. The sensor element comprises a matrix of optical sensors. The sensor element may comprise at least one CMOS sensor. The matrix may be composed of independent pixels such as of independent optical sensors. Thus, a matrix of inorganic photodiodes may be composed. Alternatively, however, a commercially available matrix may be used, such as one or more of a CCD detector, such as a CCD detector chip, and/or a CMOS detector, such as a CMOS detector chip. Thus, generally, the sensor element may be and/or may comprise at least one CCD and/or CMOS device and/or the optical sensors may form a sensor array or may be part of a sensor array, such as the above-mentioned matrix. Thus, as an example, the sensor element may comprise an array of pixels, such as a rectangular array, having m rows and n columns, with m, n, independently, being positive integers. Preferably, more than one column and more than one row is given, i.e. n>1, m>1. Thus, as an example, n may be 2 to 16 or higher and m may be 2 to 16 or higher. Preferably, the ratio of the number of rows and the number of columns is close to 1. As an example, n and m may be selected such that 0.3≤m/n≤3, such as by choosing m/n=1:1, 4:3, 16:9 or similar. As an example, the array may be a square array, having an equal number of rows and columns, such as by choosing m=2, n=2 or m=3, n=3 or the like.

The matrix may be composed of independent pixels such as of independent optical sensors. Thus, a matrix of inorganic photodiodes may be composed. Alternatively, however, a commercially available matrix may be used, such as one or more of a CCD detector, such as a CCD detector chip, and/or a CMOS detector, such as a CMOS detector chip. Thus, generally, the optical sensor may be and/or may comprise at least one CCD and/or CMOS device and/or the optical sensors may form a sensor array or may be part of a sensor array, such as the above-mentioned matrix.

The matrix specifically may be a rectangular matrix having at least one row, preferably a plurality of rows, and a plurality of columns. As an example, the rows and columns may be oriented essentially perpendicular. As used herein, the term “essentially perpendicular” refers to the condition of a perpendicular orientation, with a tolerance of e.g. +20° or less, preferably a tolerance of +10° or less, more preferably a tolerance of +5° or less. Similarly, the term “essentially parallel” refers to the condition of a parallel orientation, with a tolerance of e.g. +20° or less, preferably a tolerance of +10° or less, more preferably a tolerance of +5° or less. Thus, as an example, tolerances of less than 20°, specifically less than 10° or even less than 5°, may be acceptable. In order to provide a wide range of view, the matrix specifically may have at least 10 rows, preferably at least 500 rows, more preferably at least 1000 rows. Similarly, the matrix may have at least 10 columns, preferably at least 500 columns, more preferably at least 1000 columns. The matrix may comprise at least 50 optical sensors, preferably at least 100000 optical sensors, more preferably at least 5000000 optical sensors. The matrix may comprise a number of pixels in a multi-mega pixel range. Other embodiments, however, are feasible. Thus, in setups in which an axial rotational symmetry is to be expected, circular arrangements or concentric arrangements of the optical sensors of the matrix, which may also be referred to as pixels, may be preferred.

Thus, as an example, the sensor element may be part of or constitute a pixelated optical device. For example, the sensor element may be and/or may comprise at least one CCD and/or CMOS device. As an example, the sensor element may be part of or constitute at least one CCD and/or CMOS device having a matrix of pixels, each pixel forming a light-sensitive area. The sensor element may employ a rolling shutter or global shutter method to read out the matrix of optical sensors.

As used herein, an “optical sensor” generally refers to a light-sensitive device for detecting a light beam, such as for detecting an illumination and/or a light spot generated by at least one light beam. As further used herein, a “light-sensitive area” generally refers to an area of the optical sensor which may be illuminated externally, by the at least one light beam, in response to which illumination at least one sensor signal is generated. The light-sensitive area may specifically be located on a surface of the respective optical sensor. Other embodiments, however, are feasible. The sensor element may comprise a plurality of optical sensors each having a light sensitive area. As used herein, the term “the optical sensors each having at least one light sensitive area” refers to configurations with a plurality of single optical sensors each having one light sensitive area and to configurations with one combined optical sensor having a plurality of light sensitive areas. The term “optical sensor” furthermore refers to a light-sensitive device configured to generate one output signal. In case the sensor element comprises a plurality of optical sensors, each optical sensor may be embodied such that precisely one light-sensitive area is present in the respective optical sensor, such as by providing precisely one light-sensitive area which may be illuminated, in response to which illumination precisely one uniform sensor signal is created for the whole optical sensor. Thus, each optical sensor may be a single area optical sensor. The use of the single area optical sensors, however, renders the setup of the detector specifically simple and efficient. Thus, as an example, commercially available photo-sensors, such as commercially available silicon photodiodes, each having precisely one sensitive area, may be used in the set-up. Other embodiments, however, are feasible.

Preferably, the light sensitive area may be oriented essentially perpendicular to an optical axis. The optical axis may be a straight optical axis or may be bent or even split, such as by using one or more deflection elements and/or by using one or more beam splitters, wherein the essentially perpendicular orientation, in the latter cases, may refer to the local optical axis in the respective branch or beam path of the optical setup.

The optical sensor specifically may be or may comprise at least one photodetector, preferably inorganic photodetectors, more preferably inorganic semiconductor photodetectors, most preferably silicon photodetectors. Specifically, the optical sensor may be sensitive in the infrared spectral range. All pixels of the matrix or at least a group of the optical sensors of the matrix specifically may be identical. Groups of identical pixels of the matrix specifically may be provided for different spectral ranges, or all pixels may be identical in terms of spectral sensitivity. Further, the pixels may be identical in size and/or with regard to their electronic or optoelectronic properties. Specifically, the optical sensor may be or may comprise at least one inorganic photodiode which are sensitive in the infrared spectral range, preferably in the range of 700 nm to 3.0 micrometers. Specifically, the optical sensor may be sensitive in the part of the near infrared region where silicon photodiodes are applicable specifically in the range of 700 nm to 1100 nm. Infrared optical sensors which may be used for optical sensors may be commercially available infrared optical sensors, such as infrared optical sensors commercially available under the brand name Hertzstueck™ from trinamiX™ GmbH, D-67056 Ludwigshafen am Rhein, Germany. Thus, as an example, the optical sensor may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensor may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensor may comprise at least one photoconductive sensor such as a PbS or PbSe sensor, a bolometer, preferably a bolometer selected from the group consisting of a VO bolometer and an amorphous Si bolometer.

The optical sensor may be sensitive in one or more of the ultraviolet, the visible or the infrared spectral range. Specifically, the optical sensor may be sensitive in the visible spectral range from 500 nm to 780 nm, most preferably at 650 nm to 750 nm or at 690 nm to 700 nm. Specifically, the optical sensor may be sensitive in the near infrared region. Specifically, the optical sensor may be sensitive in the part of the near infrared region where silicon photodiodes are applicable specifically in the range of 700 nm to 1000 nm. The optical sensor, specifically, may be sensitive in the infrared spectral range, specifically in the range of 780 nm to 3.0 micrometers. For example, the optical sensor each, independently, may be or may comprise at least one element selected from the group consisting of a photodiode, a photocell, a photoconductor, a phototransistor or any combination thereof. For example, the sensor element may be or may comprise at least one element selected from the group consisting of a CCD sensor element, a CMOS sensor element, a photodiode, a photocell, a photoconductor, a phototransistor or any combination thereof. Any other type of photosensitive element may be used. The photosensitive element generally may fully or partially be made of inorganic materials and/or may fully or partially be made of organic materials. Most commonly, one or more photodiodes may be used, such as commercially available photodiodes, e.g. inorganic semiconductor photodiodes.

The detector further may comprise at least one further transfer device. The detector may further comprise one or more additional elements such as one or more additional optical elements. The detector may comprise at least one optical element selected from the group consisting of: transfer device, such as at least one lens and/or at least one lens system, at least one diffractive optical element. The further transfer device, also denoted as “transfer system”, may comprise one or more optical elements which are adapted to modify the light beam, such as by modifying one or more of a beam parameter of the light beam, a width of the light beam or a direction of the light beam. The further transfer device may be adapted to guide the light beam onto the optical sensor. The further transfer device specifically may comprise one or more of: at least one lens, for example at least one lens selected from the group consisting of at least one focus-tunable lens, at least one aspheric lens, at least one spheric lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system. The further transfer device may have a focal length. As used herein, the term “focal length” of the further transfer device refers to a distance over which incident collimated rays which may impinge the transfer device are brought into a “focus” which may also be denoted as “focal point”. Thus, the focal length constitutes a measure of an ability of the further transfer device to converge an impinging light beam. Thus, the further transfer device may comprise one or more imaging elements which can have the effect of a converging lens. By way of example, the further transfer device can have one or more lenses, in particular one or more refractive lenses, and/or one or more convex mirrors. In this example, the focal length may be defined as a distance from the center of the thin refractive lens to the principal focal points of the thin lens. For a converging thin refractive lens, such as a convex or biconvex thin lens, the focal length may be considered as being positive and may provide the distance at which a beam of collimated light impinging the thin lens as the transfer device may be focused into a single spot. Additionally, the further transfer device can comprise at least one wavelength-selective element, for example at least one optical filter. Additionally, the further transfer device can be designed to impress a predefined beam profile on the electromagnetic radiation, for example, at the location of the sensor region and in particular the sensor area. The abovementioned optional embodiments of the further transfer device can, in principle, be realized individually or in any desired combination.

The further transfer device may have an optical axis. As used herein, the term “optical axis of the further transfer device” generally refers to an axis of mirror symmetry or rotational symmetry of the lens or lens system. The further transfer system, as an example, may comprise at least one beam path, with the elements of the transfer system in the beam path being located in a rotationally symmetrical fashion with respect to the optical axis. Still, one or more optical elements located within the beam path may also be off-centered or tilted with respect to the optical axis. In this case, however, the optical axis may be defined sequentially, such as by interconnecting the centers of the optical elements in the beam path, e.g. by interconnecting the centers of the lenses, wherein, in this context, the optical sensors are not counted as optical elements. The optical axis generally may denote the beam path. Therein, the detector may have a single beam path along which a light beam may travel from the object to the optical sensors, or may have a plurality of beam paths. As an example, a single beam path may be given or the beam path may be split into two or more partial beam paths. In the latter case, each partial beam path may have its own optical axis. In case of a plurality of optical sensors, the optical sensors may be located in one and the same beam path or partial beam path. Alternatively, however, the optical sensors may also be located in different partial beam paths.

The further transfer device may constitute a coordinate system, wherein a longitudinal coordinate is a coordinate along the optical axis and wherein d is a spatial offset from the optical axis. The coordinate system may be a polar coordinate system in which the optical axis of the transfer device forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

As used herein, a “sensor signal” generally refers to a signal generated by the optical sensor and/or at least one pixel of the optical sensor in response to illumination. Specifically, the sensor signal may be or may comprise at least one electrical signal, such as at least one analogue electrical signal and/or at least one digital electrical signal. More specifically, the sensor signal may be or may comprise at least one voltage signal and/or at least one current signal. More specifically, the sensor signal may comprise at least one photocurrent. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like.

As used herein, without limitation, the term “image” specifically may relate to data recorded by using the sensor element, such as a plurality of electronic readings from the sensor element, such as the pixels of the CCD or CMOS chip. The term “imaging at least one image” may refer to capturing and/or recording the image.

The sensor element is configured for imaging at least one scene image of the object illuminated by the scene illumination. The scene image may be generated in response to the diffuse and/or uniform illumination of the object by the scene illumination. The scene image may not comprise any reflection features generated by the illumination pattern. The scene image may be at least one two-dimensional image. As used herein, the term “two dimensional image” may generally refer to an image having information about transversal coordinates such as the dimensions of height and width.

The sensor element is configured for imaging at least one reflection image comprising a plurality of reflection features generated by the object in response to the illumination pattern. Each of the reflection features comprises a beam profile. As used herein, the term “reflection feature” may refer to a feature in an image plane generated by the scene, in particular the object, in response to illumination, specifically with at least one illumination feature. Each of the reflection features comprises at least one beam profile, also denoted reflection beam profile. As used herein, the term “beam profile” of the reflection feature may generally refer to at least one intensity distribution of the reflection feature, such as of a light spot on the optical sensor, as a function of the pixel. The beam profile may be selected from the group consisting of a trapezoid beam profile; a triangle beam profile; a conical beam profile and a linear combination of Gaussian beam profiles.

The evaluation device may be configured for evaluating the reflection image. The evaluation of the reflection image may comprise identifying the reflection features of the reflection image. The evaluation device may be configured for performing at least one image analysis and/or image processing in order to identify the reflection features. The image analysis and/or image processing may use at least one feature detection algorithm. The image analysis and/or image processing may comprise one or more of the following: a filtering; a selection of at least one region of interest; a formation of a difference image between an image created by the sensor signals and at least one offset; an inversion of sensor signals by inverting an image created by the sensor signals; a formation of a difference image between an image created by the sensor signals at different times; a background correction; a decomposition into color channels; a decomposition into hue; saturation; and brightness channels; a frequency decomposition; a singular value decomposition; applying a blob detector; applying a corner detector; applying a Determinant of Hessian filter; applying a principle curvature-based region detector; applying a maximally stable extremal regions detector; applying a generalized Hough-transformation; applying a ridge detector; applying an affine invariant feature detector; applying an affine-adapted interest point operator; applying a Harris affine region detector; applying a Hessian affine region detector; applying a scale-invariant feature transform; applying a scale-space extrema detector; applying a local feature detector; applying speeded up robust features algorithm; applying a gradient location and orientation histogram algorithm; applying a histogram of oriented gradients descriptor; applying a Deriche edge detector; applying a differential edge detector; applying a spatio-temporal interest point detector; applying a Moravec corner detector; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wavelet-transformation; a thresholding; creating a binary image. The region of interest may be determined manually by a user or may be determined automatically, such as by recognizing a feature within the image generated by the optical sensor.

As further used herein, the term “evaluation device” generally refers to an arbitrary data processing device adapted to perform the named operations such as by using at least one processor and/or at least one application-specific integrated circuit. Thus, as an example, the at least one evaluation device may comprise a software code stored thereon comprising a number of computer commands. The evaluation device may provide one or more hardware elements for performing one or more of the named operations and/or may provide one or more processors with software running thereon for performing one or more of the named operations. Operations, including evaluating the images may be performed by the at least one evaluation device. Thus, as an example, one or more instructions may be implemented in software and/or hardware. Thus, as an example, the evaluation device may comprise one or more programmable devices such as one or more computers, application-specific integrated circuits (ASICs), Digital Signal Processors (DSPs), or Field Programmable Gate Arrays (FPGAs) which are configured to perform the above-mentioned evaluation. Additionally or alternatively, however, the evaluation device may also fully or partially be embodied by hardware. The evaluation device and the detector may fully or partially be integrated into a single device. Thus, generally, the evaluation device also may form part of the detector. Alternatively, the evaluation device and the detector may fully or partially be embodied as separate devices.

The evaluation device may be or may comprise one or more integrated circuits, such as one or more application-specific integrated circuits (ASICs), and/or one or more data processing devices, such as one or more computers, preferably one or more microcomputers and/or microcontrollers, Field Programmable Arrays, or Digital Signal Processors. Additional components may be comprised, such as one or more preprocessing devices and/or data acquisition devices, such as one or more devices for receiving and/or preprocessing of the sensor signals, such as one or more AD-converters and/or one or more filters. Further, the evaluation device may comprise one or more measurement devices, such as one or more measurement devices for measuring electrical currents and/or electrical voltages. Further, the evaluation device may comprise one or more data storage devices. Further, the evaluation device may comprise one or more interfaces, such as one or more wireless interfaces and/or one or more wire-bound interfaces.

The evaluation device may be configured to one or more of displaying, visualizing, analyzing, distributing, communicating or further processing of information, such as information obtained by the sensor element. The evaluation device, as an example, may be connected or incorporate at least one of a display, a projector, a monitor, an LCD, a TFT, a loudspeaker, a multichannel sound system, an LED pattern, or a further visualization device. It may further be connected or incorporate at least one of a communication device or communication interface, a connector or a port, capable of sending encrypted or unencrypted information using one or more of email, text messages, telephone, Bluetooth, Wi-Fi, infrared or internet interfaces, ports or connections. It may further be connected to or incorporate at least one of a processor, a graphics processor, a CPU, an Open Multimedia Applications Platform (OMAP™), an integrated circuit, a system on a chip such as products from the Apple A series or the Samsung S3C2 series, a microcontroller or microprocessor, one or more memory blocks such as ROM, RAM, EEPROM, or flash memory, timing sources such as oscillators or phase-locked loops, counter-timers, real-time timers, or power-on reset generators, voltage regulators, power management circuits, or DMA controllers. Individual units may further be connected by buses such as AMBA buses or be integrated in an Internet of Things or Industry 4.0 type network.

The evaluation device may be connected by or have further external interfaces or ports such as one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices such as a 2Dcamera device using an RGB-interface such as CameraLink. The evaluation device may further be connected by one or more of interprocessor interfaces or ports, FPGA-FPGA-interfaces, or serial or parallel interfaces ports. The evaluation device may further be connected to one or more of an optical disc drive, a CD-RW drive, a DVD+RW drive, a flash drive, a memory card, a disk drive, a hard disk drive, a solid state disk or a solid state hard disk.

The evaluation device may be connected by or have one or more further external connectors such as one or more of phone connectors, RCA connectors, VGA connectors, hermaphrodite connectors, USB connectors, HDMI connectors, 8P8C connectors, BCN connectors, IEC 60320 C14 connectors, optical fiber connectors, D-subminiature connectors, RF connectors, coaxial connectors, SCART connectors, XLR connectors, and/or may incorporate at least one suitable socket for one or more of these connectors.

The evaluation device may be configured for determining the beam profile of the respective reflection feature. As used herein, the term “determining the beam profile” refers to identifying at least one reflection feature provided by the optical sensor and/or selecting at least one reflection feature provided by the optical sensor and evaluating at least one intensity distribution of the reflection feature. As an example, a region of the matrix may be used and evaluated for determining the intensity distribution, such as a three-dimensional intensity distribution or a two-dimensional intensity distribution, such as along an axis or line through the matrix. As an example, a center of illumination by the light beam may be determined, such as by determining the at least one pixel having the highest illumination, and a cross-sectional axis may be chosen through the center of illumination. The intensity distribution may an intensity distribution as a function of a coordinate along this cross-sectional axis through the center of illumination. Other evaluation algorithms are feasible.

The reflection feature may cover or may extend over at least one pixel of the reflection image. For example, the reflection feature may cover or may extend over plurality of pixels. The evaluation device may be configured for determining and/or for selecting all pixels connected to and/or belonging to the reflection feature, e.g. a light spot. The evaluation device may be configured for determining the center of intensity by

$${R}_{coi} = \frac{1}{{I}_{total}} {\sum }_{j} {r}_{pixel} ( j ) I ( j )$$

wherein R_{coi} is the position of center of intensity, rₚᵢₓₑₗ (j) is the pixel position and I(j) the intensity of pixel j connected to and/or belonging to the reflection feature and Iₜₒₜₐₗ being the total intensity.

The evaluation device is configured for determining at least one first material information of the object by evaluating the beam profile of at least one of the reflection features. The evaluation device may be configured for determining the at least one first material information of the object by evaluating the beam profile of at least three or more of the reflection features, in particular of all of the reflection features.

The evaluation device may be configured for identifying a reflection feature as to be generated by an item having a specific material property in case its reflection beam profile fulfills at least one predetermined or predefined criterion. As used herein, the term “at least one predetermined or predefined criterion” refers to at least one property and/or value suitable to distinguish material properties. The predetermined or predefined criterion may be or may comprise at least one predetermined or predefined value and/or threshold and/or threshold range referring to a material property. The reflection feature may be indicated as to be generated by an item having a specific material property in case the reflection beam profile fulfills the at least one predetermined or predefined criterion. As used herein, the term “indicate” refers to an arbitrary indication such as an electronic signal and/or at least one visual or acoustic indication.

As used herein, the term “determining at least one material information” may refer to assigning at least one material property to a respective reflection feature. The evaluation device may comprise at least one database comprising a list and/or table, such as a lookup list or a lookup table, of predefined and/or predetermined material properties. The list and/or table of material properties may be determined and/or generated by performing at least one test measurement, for example by performing material tests using samples having known material properties. The list and/or table of material properties may be determined and/or generated at the manufacturer site and/or by a user. The material property may additionally be assigned to a material classifier such as one or more of a material name, a material group such as biological or non-biological material, translucent or non-translucent materials, metal or non-metal, fur or non-fur, carpet or non-carpet, reflective or non-reflective, specular reflective or non-specular reflective, foam or non-foam, roughness groups or the like. The evaluation device may comprise at least one database comprising a list and/or table comprising the material properties and associated material name and/or material group.

For determining the first material information, beam profile analysis may be used. Specifically, beam profile analysis makes use of reflection properties of coherent light projected onto object surfaces to classify materials. The classification of materials may be performed as described in WO 2020/187719, in EP application No. 20159984.2 filed on Feb. 28, 2020 and/or EP application 20 154 961.5 filed on Jan. 31, 2020, and C. Lennartz, F. Schick, S. Metz, “Whitepaper—Beam Profile Analysis for 3D imaging and material detection” Apr. 28, 2021, Ludwigshafen, Germany, the full content of which is included by reference. Specifically, a periodic grid of laser spots, e.g. a hexagonal grid as described in EP application 20 170 905.2 filed on Apr. 22, 2020, is projected and the reflection image is recorded with the camera. Analyzing the beam profile of each reflection feature recorded by the sensor element may be performed by feature-based methods and/or using based on a convolutional neural network classifying the reflection features of the reflection image. The feature based methods may be used in combination with machine learning methods which may allow parametrization of a classification model. Convolutional neuronal networks may be utilized to classify materials by using the reflection images as an input.

The feature-based methods may be explained in the following. The evaluation device may be configured for comparing the reflection beam profile with at least one predetermined and/or prerecorded and/or predefined beam profile. The predetermined and/or prerecorded and/or predefined beam profile may be stored in a table or a lookup table and may be determined e.g. empirically, and may, as an example, be stored in at least one data storage device. For example, the predetermined and/or prerecorded and/or predefined beam profile may be determined during initial start-up of a device executing the method according to the present invention. For example, the predetermined and/or prerecorded and/or predefined beam profile may be stored in at least one data storage device of the evaluation device, e.g. by software, specifically by the app downloaded from an app store or the like. The reflection feature may be identified as to be generated by an item having a material property m in case the reflection beam profile and the predetermined and/or prerecorded and/or predefined beam profile are identical. The comparison may comprise overlaying the reflection beam profile and the predetermined or predefined beam profile such that their centers of intensity match. The comparison may comprise determining a deviation, e.g. a sum of squared point to point distances, between the reflection beam profile and the predetermined and/or prerecorded and/or predefined beam profile. The evaluation device may be adapted to compare the determined deviation with at least one threshold, wherein in case the determined deviation is below and/or equal the threshold the surface is indicated as biological tissue and/or the detection of biological tissue is confirmed. The threshold value may be stored in a table or a lookup table and may be determined e.g. empirically and may, as an example, be stored in at least one data storage device of the evaluation device.

Additionally or alternatively, the material characteristics may be determined by applying at least one image filter to the refection image. As further used herein, the term “image” refers to a two-dimensional function, f(x,y), wherein brightness and/or color values are given for any x,y-position in the image. The position may be discretized corresponding to the recording pixels. The brightness and/or color may be discretized corresponding to a bit-depth of the optical sensors. As used herein, the term “image filter” refers to at least one mathematical operation applied to the beam profile and/or to the at least one specific region of the beam profile. Specifically, the image filter ϕ maps an image f, or a region of interest in the image, onto a real number, ϕ(f(x,y))=φ, wherein φ denotes a feature, in particular a material feature. Images may be subject to noise and the same holds true for features. Therefore, features may be random variables. The features may be normally distributed. If features are not normally distributed, they may be transformed to be normally distributed such as by a Box-Cox-Transformation.

The evaluation device may be configured for determining at least one material feature φ₂ₘ by applying at least one material dependent image filter ϕ₂ to the image. As used herein, the term “material dependent” image filter refers to an image having a material dependent output. The output of the material dependent image filter is denoted herein “material feature φ₂ₘ” or “material dependent feature φ₂ₘ”. The material feature may be or may comprise at least one information about the at least one material property of the surface of the scene having generated the reflection feature.

The material dependent image filter may be at least one filter selected from the group consisting of: a luminance filter; a spot shape filter; a squared norm gradient; a standard deviation; a smoothness filter such as a Gaussian filter or median filter; a grey-level-occurrence-based contrast filter; a grey-level-occurrence-based energy filter; a grey-level-occurrence-based homogeneity filter; a grey-level-occurrence-based dissimilarity filter; a Law's energy filter; a threshold area filter; or a linear combination thereof; or a further material dependent image filter ϕ₂ₒₜₕₑᵣ which correlates to one or more of the luminance filter, the spot shape filter, the squared norm gradient, the standard deviation, the smoothness filter, the grey-level-occurrence-based energy filter, the grey-level-occurrence-based homogeneity filter, the grey-level-occurrence-based dissimilarity filter, the Law's energy filter, or the threshold area filter, or a linear combination thereof by |ρ_{ϕ2other,ϕm}|≥0.40 with ϕₘ being one of the luminance filter, the spot shape filter, the squared norm gradient, the standard deviation, the smoothness filter, the grey-level-occurrence-based energy filter, the grey-level-occurrence-based homogeneity filter, the grey-level-occurrence-based dissimilarity filter, the Law's energy filter, or the threshold area filter, or a linear combination thereof. The further material dependent image filter ϕ₂ₒₜₕₑᵣ may correlate to one or more of the material dependent image filters ϕₘ by |ρ_{ϕ2other,ϕm}|≥0.60, preferably by |ρ_{ϕ2other,ϕm}|≥0.80.

The material dependent image filter may be at least one arbitrary filter @ that passes a hypothesis testing. As used herein, the term “passes a hypothesis testing” refers to the fact that a Null-hypothesis H₀ is rejected and an alternative hypothesis H₁ is accepted. The hypothesis testing may comprise testing the material dependency of the image filter by applying the image filter to a predefined data set. The data set may comprise a plurality of beam profile images. As used herein, the term “beam profile image” refers to a sum of N_{B} Gaussian radial basis functions,

$${f}_{k} ( x , y ) = \vert {\sum }_{l = 0}^{{N}_{B} - 1} {g}_{lk} ( x , y ) \vert ,$$

$${g}_{lk} ( x , y ) = {a}_{lk} {e}^{- {( α ( x - {x}_{lk} ) )}^{2}} {e}^{- {( α ( y - {y}_{lk} ) )}^{2}}$$

wherein each of the N_{B} Gaussian radial basis functions is defined by a center (xₗₖ, yₗₖ), a prefactor, aₗₖ, and an exponential factor α=1/∈. The exponential factor is identical for all Gaussian functions in all images. The center-positions, xₗₖ, yₗₖ, are identical for all images ƒₖ: (x₀, x₁, . . . , x_{N}_{_{B-1}}), (y₀, y₁, . . . , y_{N}_{_{B}}₋₁). Each of the beam profile images in the dataset may correspond to a material classifier and a distance. The material classifier may be a label such as ‘Material A’, ‘Material B’, etc. The beam profile images may be generated by using the above formula for ƒₖ(x, y) in combination with the following parameter table:

| Image | Material classifier, | Distance | |
|---|---|---|---|
| Index | Material Index | z | Parameters |
| k = 0 | Skin, m = 0 | 0.4 m | (a₀₀, a₁₀, . . . , a_{N}_{_{B}}₋₁₀) |
| k = 1 | Skin, m = 0 | 0.6 m | (a₀₁, a₁₁, . . . , a_{N}_{_{B}}₋₁₁) |
| k = 2 | Fabric, m = 1 | 0.6 m | (a₀₂, a₁₂, . . . , a_{N}_{_{B}}₋₁₂) |
| . | | . | |
| . | | . | |
| . | | . | |
| k = N | Material J, m = J − 1 | | (a_{0N}, a_{1N}, . . . , a_{N}_{_{B}}_{-1N}) |

The values for x, y, are integers corresponding to pixels with (_{y}^{x})∈[0, 1, . . . 31]². The images may have a pixel size of 32×32. The dataset of beam profile images may be generated by using the above formula for ƒₖ in combination with a parameter set to obtain a continuous description of ƒₖ. The values for each pixel in the 32×32-image may be obtained by inserting integer values from 0, . . . , 31 for x, y, in ƒₖ(x, y). For example, for pixel (6,9), the value ƒₖ(6,9) may be computed.

Subsequently, for each image ƒₖ, the feature value φₖ corresponding to the filter ϕ may be calculated, Φ(ƒₖ(x, y),zₖ)=φₖ, wherein zₖ is a distance value corresponding to the image ƒₖ from the predefined data set. This yields a dataset with corresponding generated feature values φₖ. The hypothesis testing may use a Null-hypothesis that the filter does not distinguish between material classifier. The Null-Hypothesis may be given by H₀:μ₁=μ₂= . . . =μ_{J}, wherein μₘ is the expectation value of each material-group corresponding to the feature values φₖ. Index m denotes the material group. The hypothesis testing may use as alternative hypothesis that the filter does distinguish between at least two material classifiers. The alternative hypothesis may be given by H₁: ∃m, m′: μₘ≠μ_{m′}. As used herein, the term “not distinguish between material classifiers” refers to that the expectation values of the material classifiers are identical. As used herein, the term “distinguishes material classifiers” refers to that at least two expectation values of the material classifiers differ. As used herein “distinguishes at least two material classifiers” is used synonymous to “suitable material classifier”. The hypothesis testing may comprise at least one analysis of variance (ANOVA) on the generated feature values. In particular, the hypothesis testing may comprise determining a mean-value of the feature values for each of the J materials, i.e. in total J mean values,

$${\overline{φ}}_{m} = \frac{{\sum }_{i} {φ}_{i , m}}{{N}_{m}} ,$$

tor m∈[0, 1, . . . , J−1], wherein Nₘ gives the number of feature values for each of the/materials in the predefined data set. The hypothesis testing may comprise determining a mean-value of all N feature values

$$\overline{φ} = \frac{{\sum }_{m} {\sum }_{i} {φ}_{i , m}}{N} .$$

The hypothesis testing may comprise determining a Mean Sum Squares within:

$$m s s w = ( {\sum }_{m} {\sum }_{i} {( {φ}_{i , m} - {\overline{φ}}_{m} )}^{2} ) / ( N - J ) .$$

The hypothesis testing may comprise determining a Mean Sum of Squares between,

$$m s s b = ( {\sum }_{m} {( {\overline{φ}}_{m} - \overline{φ} )}^{2} {N}_{m} ) / ( J - 1 ) .$$

The hypothesis testing may comprise performing an F-Test:

$$C D F ( x ) = {I}_{\frac{{d}_{1} x}{{d}_{1} x + {d}_{2}}} ( \frac{{d}_{1}}{2} , \frac{{d}_{2}}{2} ) , where {d}_{1} = N - J , {d}_{2} = J - 1 ,$$

$$F ( x ) = 1 - C D F ( x )$$

$$p = F ( mssb / mssw )$$

Herein, Iₓ is the regularized incomplete Beta-Function,

$${I}_{x} ( a , b ) = \frac{B ( x ; a , b )}{B ( a , b )} ,$$

with the Euler Beta-Function B(a, b)=∫₀¹ t^{a-1}(1−t)^{b-1}dt and B(x; a, b)=∫₀^{x} t^{a-1}(1−t)^{b-1}dt being the incomplete Beta-Function. The image filter may pass the hypothesis testing if a p-value, p, is smaller or equal than a pre-defined level of significance. The filter may pass the hypothesis testing if p≤0.075, preferably p≤0.05, more preferably p≤0.025, and most preferably p≤0.01. For example, in case the pre-defined level of significance is α=0.075, the image filter may pass the hypothesis testing if the p-value is smaller than α=0.075. In this case the Null-hypothesis H₀ can be rejected and the alternative hypothesis H₁ can be accepted. The image filter thus distinguishes at least two material classifiers. Thus, the image filter passes the hypothesis testing.

In the following, image filters are described assuming that the reflection image comprises at least one reflection feature, in particular a spot image. A spot image ƒ may be given by a function ƒ: [symbol] ²→ [symbol] _{≥0}, wherein the background of the image ƒ may be already subtracted. However, other reflection features may be possible.

For example, the material dependent image filter may be a luminance filter. The luminance filter may return a luminance measure of a spot as material feature. The material feature may be determined by

$${φ}_{2 m} = Φ ( f , z ) = - \int f ( x ) d x \frac{{z}^{2}}{{d}_{ray} \cdot n} ,$$

where f is the spot image. The distance of the spot is denoted by z, where z may be obtained for example by using a depth-from-defocus or depth-from-photon ratio technique and/or by using a triangulation technique. The surface normal of the material is given by n∈ [symbol] ³ and can be obtained as the normal of the surface spanned by at least three measured points. The vector d_{ray}∈ [symbol] ³ is the direction vector of the light source. Since the position of the spot is known by using a depth-from-defocus or depth-from-photon ratio technique and/or by using a triangulation technique wherein the position of the light source is known as a parameter of the detector system, d_{ray}, is the difference vector between spot and light source positions.

For example, the material dependent image filter may be a filter having an output dependent on a spot shape. This material dependent image filter may return a value which correlates to the translucence of a material as material feature. The translucence of materials influences the shape of the spots. The material feature may be given by

$${φ}_{2 m} = Φ ( f ) = \frac{\int H ( f ( x ) - α h ) d x}{\int H ( f ( x ) - β h ) d x} ,$$

wherein 0<α, β<1 are weights for the spot height h, and H denotes the Heavyside function, i.e. H(x)=1:x≥0, H(x)=0:x<0. The spot height h may be determined by

$$h = {\int }_{{B}_{r}} f ( x ) dx ,$$

where Bᵣ is an inner circle of a spot with radius r.

For example, the material dependent image filter may be a squared norm gradient. This material dependent image filter may return a value which correlates to a measure of soft and hard transitions and/or roughness of a spot as material feature. The material feature may be defined by

$${φ}_{2 m} = Φ ( f ) = \int {‖ ∇ f ( x ) ‖}^{2} d x .$$

For example, the material dependent image filter may be a standard deviation. The standard deviation of the spot may be determined by

$${φ}_{2 m} = Φ ( f ) = \int {( f ( x ) - μ )}^{2} d x ,$$

Wherein μ is the mean value given by μ=∫(ƒ(x))dx.

For example, the material dependent image filter may be a smoothness filter such as a Gaussian filter or median filter. In one embodiment of the smoothness filter, this image filter may refer to the observation that volume scattering exhibits less speckle contrast compared to diffuse scattering materials. This image filter may quantify the smoothness of the spot corresponding to speckle contrast as material feature. The material feature may be determined by

$${φ}_{2 m} = Φ ( f , z ) = \frac{\int \vert ℱ ( f ) ( x ) - f ( x ) \vert dx}{\int f ( x ) d x} \cdot \frac{1}{z} ,$$

wherein [symbol] is a smoothness function, for example a median filter or Gaussian filter. This image filter may comprise dividing by the distance z, as described in the formula above. The distance z may be determined for example using a depth-from-defocus or depth-from-photon ratio technique and/or by using a triangulation technique. This may allow the filter to be insensitive to distance. In one embodiment of the smoothness filter, the smoothness filter may be based on the standard deviation of an extracted speckle noise pattern. A speckle noise pattern N can be described in an empirical way by

$$f ( x ) = {f}_{0} ( x ) \cdot ( N ( X ) + 1 ) ,$$

where ƒ₀ is an image of a despeckled spot. N(X) is the noise term that models the speckle pattern. The computation of a despeckled image may be difficult. Thus, the despeckled image may be approximated with a smoothed version of f, i.e. ƒ₀≈ [symbol] (ƒ), wherein [symbol] is a smoothness operator like a Gaussian filter or median filter. Thus, an approximation of the speckle pattern may be given by

$$N ( X ) = \frac{f ( x )}{ℱ ( f ( x ) )} - 1 .$$

The material feature of this filter may be determined by

$${φ}_{2 m} = Φ ( f ) = \sqrt{Var ( \frac{f}{ℱ ( f )} - 1 )} ,$$

Wherein Var denotes the variance function.

For example, the image filter may be a grey-level-occurrence-based contrast filter. This material filter may be based on the grey level occurrence matrix M_{ƒ,ρ}(g₁g₂)=[ [symbol] _{g1,g2}], whereas [symbol] _{g1,g2} is the occurrence rate of the grey combination (g₁,g₂)=[f(x₁,y₁),f(x₂,y₂)], and the relation ρ defines the distance between (x₁,y₁) and (x₂,y₂), which is ρ(x,y)=(x+a,y+b) with a and b selected from 0,1.

The material feature of the grey-level-occurrence-based contrast filter may be given by

$${φ}_{2 m} = Φ ( f ) = {\sum }_{i , j = 0}^{N - 1} {{p}_{i j} ( i - j )}^{2} .$$

For example, the image filter may be a grey-level-occurrence-based energy filter. This material filter is based on the grey level occurrence matrix defined above.

The material feature of the grey-level-occurrence-based energy filter may be given by

$${φ}_{2 m} = Φ ( f ) = {\sum }_{i , j = 0}^{N - 1} {( {p}_{i j} )}^{2} .$$

For example, the image filter may be a grey-level-occurrence-based homogeneity filter. This material filter is based on the grey level occurrence matrix defined above.

The material feature of the grey-level-occurrence-based homogeneity filter may be given by

$${φ}_{2 m} = Φ ( f ) = {\sum }_{i , j = 0}^{N - 1} \frac{{p}_{i j}}{1 + \vert i - j \vert} .$$

For example, the image filter may be a grey-level-occurrence-based dissimilarity filter. This material filter is based on the grey level occurrence matrix defined above.

The material feature of the grey-level-occurrence-based dissimilarity filter may be given by

$${φ}_{2 m} = Φ ( f ) = - {\sum }_{i , j = 0}^{N - 1} \sqrt{{p}_{i j} log ( {p}_{i j} )} .$$

For example, the image filter may be a Law's energy filter. This material filter may be based on the laws vector L₅=[1,4,6,4,1] and E₅=[−1,−2,0,−2,−1] and the matrices L₅(E₅)^{T} and E₅(L₅)^{T}.

The image fₖ is convoluted with these matrices:

$${f}_{k , L 5 E 5}^{*} ( x , y ) = {\sum }_{i - 2}^{2} {\sum }_{j - 2}^{2} {f}_{k} ( x + i , y + j ) {{L}_{5} ( {E}_{5} )}^{T}$$

$${f}_{k , E 5 L 5}^{*} ( x , y ) = {\sum }_{i - 2}^{2} {\sum }_{j - 2}^{2} {f}_{k} ( x + i , y + j ) {{E}_{5} ( {L}_{5} )}^{T} .$$

and

$$\begin{matrix}E = \int \frac{{f}_{k , L 5 E 5}^{*} ( x , y )}{max ( {f}_{k , L 5 E 5}^{*} ( x , y ) )} d x dy , \\ F = \int \frac{{f}_{k , E 5 L 5}^{*} ( x , y )}{max ( {f}_{k , E 5 L 5}^{*} ( x , y ) )} d x d y ,\end{matrix}$$

Whereas the material feature of Law's energy filter may be determined by

$${φ}_{2 m} = Φ ( f ) = E / F .$$

For example, the material dependent image filter may be a threshold area filter. This material feature may relate two areas in the image plane. A first area Ω1, may be an area wherein the function f is larger than α times the maximum of f. A second area Ω2, may be an area wherein the function f is smaller than α times the maximum of f, but larger than α threshold value & times the maximum of f. Preferably α may be 0.5 and ε may be 0.05. Due to speckles or noise, the areas may not simply correspond to an inner and an outer circle around the spot center. As an example, Ω1 may comprise speckles or unconnected areas in the outer circle. The material feature may be determined by

$${φ}_{2 m} = Φ ( f ) = \frac{{\int }_{Ω 1} 1}{{\int }_{Ω 2} 1} ,$$

wherein Ω1={x|f(x)>α·max(f(x))} and Ω2={x|ε·max(f(x))<f(x)<α·max(f(x))}.

The evaluation device may be configured for using at least one predetermined relationship between the material feature φ₂ₘ and the material property of the surface having generated the reflection feature for determining the material property of the surface having generated the reflection feature. The predetermined relationship may be one or more of an empirical relationship, a semi-empiric relationship and an analytically derived relationship. The evaluation device may comprise at least one data storage device for storing the predetermined relationship, such as a lookup list or a lookup table.

The determining of the at least one first material information may comprise using artificial intelligence, in particular convolutional neuronal networks. Using reflection images as input for convolutional neuronal networks may enable the generation of classification models with sufficient accuracy to differentiate between materials. Since only physically valid information is passed to the network by selecting important regions in the reflection image, only compact training data sets may be needed. Additionally, very compact network architectures can be generated.

Specifically, for determining of the at least one first material information at least one parametrized classification model may be used. The parametrized classification model may be configured for classifying materials by using the reflection image as an input. The classification model may be parametrized by using one or more of machine learning, deep learning, neural networks, or other form of artificial intelligence. The term “machine-learning” as used herein is a broad term and is to be given its ordinary and customary meaning to a person of ordinary skill in the art and is not to be limited to a special or customized meaning. The term specifically may refer, without limitation, to a method of using artificial intelligence (AI) for automatically model building, in particular for parametrizing models. The classification model may be a classification model configured for discriminating materials. The material characteristics may be determined by applying an optimization algorithm in terms of at least one optimization target on the classification model. The machine learning may be based on at least one neuronal network, in particular a convolutional neural network. Weights and/or topology of the neuronal network may be pre-determined and/or pre-defined. Specifically, training of the classification model may be performed using machine-learning. The classification model may comprise at least one machine-learning architecture and model parameters. For example, the machine-learning architecture may be or may comprise one or more of: linear regression, logistic regression, random forest, naive Bayes classifications, nearest neighbors, neural networks, convolutional neural networks, generative adversarial networks, support vector machines, or gradient boosting algorithms or the like. The term “training”, also denoted learning, as used herein, is a broad term and is to be given its ordinary and customary meaning to a person of ordinary skill in the art and is not to be limited to a special or customized meaning. The term specifically may refer, without limitation, to a process of building the model, in particular determining and/or updating parameters of the model. The classification model may be at least partially data-driven. For example, the parametrized classification model may be based on experimental data. For example, the training may comprise using at least one training dataset, wherein the training data set comprises images, in particular reflection images, of a plurality of items with known material property.

The evaluation device is configured for determining at least one second material information of the object by evaluating the scene image. The evaluation of the scene image may comprise determining at least one reflectance value of at least one region of interest. The region of interest may be selected manually by a user and/or automatically by using at least one object detection algorithm. The evaluation may comprise comparing the reflectance value to at least one predetermined or predefined value and/or threshold and/or threshold range referring to a material property. The determination of the second material information may be performed using at least one parametrized classification model. The parametrized model may be a combined parametrized classification model for determining the first material information and the second material information and/or at least one further parametrized classification model, in particular in addition to the parametrized model used for determining the first material information. The combined parametrized classification model and/or the further parametrized classification model may be at least partially data-driven. For example, the combined parametrized classification model and/or the further parametrized classification model may be based on experimental data. For example, the training may comprise using at least one training dataset, wherein the training data set comprises images, in particular scene images of a plurality of items with known material property for the further parametrized model and/or scene images and reflection images for the combined parametrized classification model.

The determination of the second material information may be performed sequentially or simultaneously to the determination of the first material information. The at least second material information may be used separately and/or together with the first material information. The evaluation of the scene image can be performed sequentially or simultaneously to the evaluation of the reflection image using the at least one parametrized classification model. The evaluation device may be configured for determining a final material classification, The final material classification may be the combination of the results of the at parametrized classification model(s) using the first and second material information.

For example, the evaluation device may be configured for sequentially using the first material information and at least one parametrized classification model providing at least one material confidence for deciding whether the at least one second material information needs to be evaluated. For example, if skin or non-skin must be classified and the first material information rejects skin with high confidence, the second material information might be not necessary for the final classification decision. The decision, if the second material information is used, may be evaluated using the at least one parametrized classification model.

For example, the evaluation may be performed simultaneously, e.g. using the combined parametrized classification model.

The evaluation device may be configured for determining a combination of the results of the parametrized classification model(s) using the first and second material information. The combination of the first and second material information may allow material classification with enhanced confidence.

The first material information may be a material property characterizing the material of the object. The evaluation device may be configured for using the second material information as an additional information channel for distinguishing between materials, e.g. in case of ambiguities. Using an additional information channel may be advantageous in case of difficult targets such as distinguishing skin and silicon. The detector may be configured for distinguish between biological or non-biological material. The detector may be configured for distinguish between skin and non-skin objects.

The evaluation device is configured for determining the material of the object using the first material information and the second material information. The evaluation device may be configured for determining the material of the object by using the first material information only. This may be suitable for many materials. However, in case of different targets, i.e. targets having similar reflectance values at the first wavelength, the second material information may be considered by the evaluation device for distinguishing between the materials. This may significantly increase reliability of material detection and, thus, increases likelihood of identifying spoofing attacks.

The evaluation device is configured for determining a longitudinal coordinate of at least one of the reflection features by analysis of its respective beam profile. The evaluation device may be configured for determining at least one longitudinal coordinate z_{DPR} for each of the reflection features by analysis of the beam profile of the respective reflection feature. The evaluation device may be configured for determining the longitudinal coordinate z_{DPR} for the reflection features by using the so called depth-from-photon-ratio technique, also denoted as beam profile analysis. With respect to depth-from-photon-ratio (DPR) technique reference is made to WO 2018/091649 A1, WO 2018/091638 A1 and WO 2018/091640 A1 and C. Lennartz, F. Schick, S. Metz, “Whitepaper-Beam Profile Analysis for 3D imaging and material detection” Apr. 28, 2021, Ludwigshafen, Germany, the full content of which is included by reference.

The determining of the longitudinal coordinate, i.e. the depth information, for the reflection feature comprises evaluating the reflection image. The evaluation may comprises, for at least one, in particular for each reflection feature, an analysis of its respective beam profile using a depth-from-photon ratio technique. The analysis of the beam profile comprise evaluating of the beam profile and may comprise at least one mathematical operation and/or at least one comparison and/or at least symmetrizing and/or at least one filtering and/or at least one normalizing. For example, the analysis of the beam profile may comprise at least one of a histogram analysis step, a calculation of a difference measure, application of a neural network, application of a machine learning algorithm. The evaluation device may be configured for symmetrizing and/or for normalizing and/or for filtering the beam profile, in particular to remove noise or asymmetries from recording under larger angles, recording edges or the like. The evaluation device may filter the beam profile by removing high spatial frequencies such as by spatial frequency analysis and/or median filtering or the like. Summarization may be performed by center of intensity of the light spot and averaging all intensities at the same distance to the center. The evaluation device may be configured for normalizing the beam profile to a maximum intensity, in particular to account for intensity differences due to the recorded distance. The evaluation device may be configured for removing influences from background light from the beam profile, for example, by an imaging without illumination.

The evaluation device may be configured for determining at least one first area and at least one second area of the reflection beam profile of each of the reflection features and/or of the reflection features in at least one region of interest. The evaluation device is configured for integrating the first area and the second area.

The analysis of the beam profile of one of the reflection features may comprise determining at least one first area and at least one second area of the beam profile. The first area of the beam profile may be an area A1 and the second area of the beam profile may be an area A2. The evaluation device may be configured for integrating the first area and the second area. The evaluation device may be configured to derive a combined signal, in particular a quotient Q, by one or more of dividing the integrated first area and the integrated second area, dividing multiples of the integrated first area and the integrated second area, dividing linear combinations of the integrated first area and the integrated second area. The evaluation device may configured for determining at least two areas of the beam profile and/or to segment the beam profile in at least two segments comprising different areas of the beam profile, wherein overlapping of the areas may be possible as long as the areas are not congruent. For example, the evaluation device may be configured for determining a plurality of areas such as two, three, four, five, or up to ten areas. The evaluation device may be configured for segmenting the light spot into at least two areas of the beam profile and/or to segment the beam profile in at least two segments comprising different areas of the beam profile. The evaluation device may be configured for determining for at least two of the areas an integral of the beam profile over the respective area. The evaluation device may be configured for comparing at least two of the determined integrals. Specifically, the evaluation device may be configured for determining at least one first area and at least one second area of the beam profile. As used herein, the term “area of the beam profile” generally refers to an arbitrary region of the beam profile at the position of the optical sensor used for determining the quotient Q. The first area of the beam profile and the second area of the beam profile may be one or both of adjacent or overlapping regions. The first area of the beam profile and the second area of the beam profile may be not congruent in area. For example, the evaluation device may be configured for dividing a sensor region of the CMOS sensor into at least two sub-regions, wherein the evaluation device may be configured for dividing the sensor region of the CMOS sensor into at least one left part and at least one right part and/or at least one upper part and at least one lower part and/or at least one inner and at least one outer part. Additionally or alternatively, the camera may comprise at least two optical sensors, wherein the light-sensitive areas of a first optical sensor and of a second optical sensor may be arranged such that the first optical sensor is adapted to determine the first area of the beam profile of the reflection feature and that the second optical sensor is adapted to determine the second area of the beam profile of the reflection feature. The evaluation device may be adapted to integrate the first area and the second area. The evaluation device may be configured for using at least one predetermined relationship between the quotient Q and the longitudinal coordinate for determining the longitudinal coordinate. The predetermined relationship may be one or more of an empiric relationship, a semi-empiric relationship and an analytically derived relationship. The evaluation device may comprise at least one data storage device for storing the predetermined relationship, such as a lookup list or a lookup table.

The first area of the beam profile may comprise essentially edge information of the beam profile and the second area of the beam profile comprises essentially center information of the beam profile, and/or the first area of the beam profile may comprise essentially information about a left part of the beam profile and the second area of the beam profile comprises essentially information about a right part of the beam profile. The beam profile may have a center, i.e. a maximum value of the beam profile and/or a center point of a plateau of the beam profile and/or a geometrical center of the light spot, and falling edges extending from the center. The second region may comprise inner regions of the cross section and the first region may comprise outer regions of the cross section. As used herein, the term “essentially center information” generally refers to a low proportion of edge information, i.e. proportion of the intensity distribution corresponding to edges, compared to a proportion of the center information, i.e. proportion of the intensity distribution corresponding to the center. Preferably, the center information has a proportion of edge information of less than 10%, more preferably of less than 5%, most preferably the center information comprises no edge content. As used herein, the term “essentially edge information” generally refers to a low proportion of center information compared to a proportion of the edge information. The edge information may comprise information of the whole beam profile, in particular from center and edge regions. The edge information may have a proportion of center information of less than 10%, preferably of less than 5%, more preferably the edge information comprises no center content. At least one area of the beam profile may be determined and/or selected as second area of the beam profile if it is close or around the center and comprises essentially center information. At least one area of the beam profile may be determined and/or selected as first area of the beam profile if it comprises at least parts of the falling edges of the cross section. For example, the whole area of the cross section may be determined as first region.

Other selections of the first area A1 and second area A2 may be feasible. For example, the first area may comprise essentially outer regions of the beam profile and the second area may comprise essentially inner regions of the beam profile. For example, in case of a two-dimensional beam profile, the beam profile may be divided in a left part and a right part, wherein the first area may comprise essentially areas of the left part of the beam profile and the second area may comprise essentially areas of the right part of the beam profile.

The edge information may comprise information relating to a number of photons in the first area of the beam profile and the center information may comprise information relating to a number of photons in the second area of the beam profile. The evaluation device may be configured for determining an area integral of the beam profile. The evaluation device may be configured for determining the edge information by integrating and/or summing of the first area. The evaluation device may be configured for determining the center information by integrating and/or summing of the second area. For example, the beam profile may be a trapezoid beam profile and the evaluation device may be configured for determining an integral of the trapezoid. Further, when trapezoid beam profiles may be assumed, the determination of edge and center signals may be replaced by equivalent evaluations making use of properties of the trapezoid beam profile such as determination of the slope and position of the edges and of the height of the central plateau and deriving edge and center signals by geometric considerations.

In one embodiment, A1 may correspond to a full or complete area of a feature point on the optical sensor. A2 may be a central area of the feature point on the optical sensor. The central area may be a constant value. The central area may be smaller compared to the full area of the feature point. For example, in case of a circular feature point, the central area may have a radius from 0.1 to 0.9 of a full radius of the feature point, preferably from 0.4 to 0.6 of the full radius.

In one embodiment, the illumination pattern may comprise at least one line pattern. A1 may correspond to an area with a full line width of the line pattern on the optical sensors, in particular on the light sensitive area of the optical sensors. The line pattern on the optical sensor may be widened and/or displaced compared to the line pattern of the illumination pattern such that the line width on the optical sensors is increased. In particular, in case of a matrix of optical sensors, the line width of the line pattern on the optical sensors may change from one column to another column. A2 may be a central area of the line pattern on the optical sensor. The line width of the central area may be a constant value, and may in particular correspond to the line width in the illumination pattern. The central area may have a smaller line width compared to the full line width. For example, the central area may have a line width from 0.1 to 0.9 of the full line width, preferably from 0.4 to 0.6 of the full line width. The line pattern may be segmented on the optical sensors. Each column of the matrix of optical sensors may comprise center information of intensity in the central area of the line pattern and edge information of intensity from regions extending further outwards from the central area to edge regions of the line pattern.

In one embodiment, the illumination pattern may comprise at least point pattern. A1 may correspond to an area with a full radius of a point of the point pattern on the optical sensors. A2 may be a central area of the point in the point pattern on the optical sensors. The central area may be a constant value. The central area may have a radius compared to the full radius. For example, the central area may have a radius from 0.1 to 0.9 of the full radius, preferably from 0.4 to 0.6 of the full radius.

The illumination pattern may comprise both at least one point pattern and at least one line pattern. Other embodiments in addition or alternatively to line pattern and point pattern are feasible.

The evaluation device may be configured to derive a quotient Q by one or more of dividing the integrated first area and the integrated second area, dividing multiples of the integrated first area and the integrated second area, dividing linear combinations of the integrated first area and the integrated second area.

The evaluation device may be configured to derive the quotient Q by one or more of dividing the first area and the second area, dividing multiples of the first area and the second area, dividing linear combinations of the first area and the second area. The evaluation device may be configured for deriving the quotient Q by

$$Q = \frac{\int {\int }_{A 1} E ( x , y ) dxdy}{\int {\int }_{A 2} E ( x , y ) dxdy}$$

wherein x and y are transversal coordinates, A1 and A2 are the first and second area of the beam profile, respectively, and E (x,y) denotes the beam profile.

Additionally or alternatively, the evaluation device may be adapted to determine one or both of center information or edge information from at least one slice or cut of the light spot. This may be realized, for example, by replacing the area integrals in the quotient Q by a line integral along the slice or cut. For improved accuracy, several slices or cuts through the light spot may be used and averaged. In case of an elliptical spot profile, averaging over several slices or cuts may result in improved distance information.

For example, in case of the optical sensor having a matrix of pixels, the evaluation device may be configured for evaluating the beam profile, by
determining the pixel having the highest sensor signal and forming at least one center signal;
evaluating sensor signals of the matrix and forming at least one sum signal;
determining the quotient Q by combining the center signal and the sum signal; and
determining at least one longitudinal coordinate z of the object by evaluating the quotient Q.

The term “center signal” generally refers to the at least one sensor signal comprising essentially center information of the beam profile. As used herein, the term “highest sensor signal” refers to one or both of a local maximum or a maximum in a region of interest. For example, the center signal may be the signal of the pixel having the highest sensor signal out of the plurality of sensor signals generated by the pixels of the entire matrix or of a region of interest within the matrix, wherein the region of interest may be predetermined or determinable within an image generated by the pixels of the matrix. The center signal may arise from a single pixel or from a group of optical sensors, wherein, in the latter case, as an example, the sensor signals of the group of pixels may be added up, integrated or averaged, in order to determine the center signal. The group of pixels from which the center signal arises may be a group of neighboring pixels, such as pixels having less than a predetermined distance from the actual pixel having the highest sensor signal, or may be a group of pixels generating sensor signals being within a predetermined range from the highest sensor signal. The group of pixels from which the center signal arises may be chosen as large as possible in order to allow maximum dynamic range. The evaluation device may be adapted to determine the center signal by integration of the plurality of sensor signals, for example the plurality of pixels around the pixel having the highest sensor signal. For example, the beam profile may be a trapezoid beam profile and the evaluation device may be adapted to determine an integral of the trapezoid, in particular of a plateau of the trapezoid.

As outlined above, the center signal generally may be a single sensor signal, such as a sensor signal from the pixel in the center of the light spot, or may be a combination of a plurality of sensor signals, such as a combination of sensor signals arising from pixels in the center of the light spot, or a secondary sensor signal derived by processing a sensor signal derived by one or more of the aforementioned possibilities. The determination of the center signal may be performed electronically, since a comparison of sensor signals is fairly simply implemented by conventional electronics, or may be performed fully or partially by software. Specifically, the center signal may be selected from the group consisting of: the highest sensor signal; an average of a group of sensor signals being within a predetermined range of tolerance from the highest sensor signal; an average of sensor signals from a group of pixels containing the pixel having the highest sensor signal and a predetermined group of neighboring pixels; a sum of sensor signals from a group of pixels containing the pixel having the highest sensor signal and a predetermined group of neighboring pixels; a sum of a group of sensor signals being within a predetermined range of tolerance from the highest sensor signal; an average of a group of sensor signals being above a predetermined threshold; a sum of a group of sensor signals being above a predetermined threshold; an integral of sensor signals from a group of optical sensors containing the optical sensor having the highest sensor signal and a predetermined group of neighboring pixels; an integral of a group of sensor signals being within a predetermined range of tolerance from the highest sensor signal; an integral of a group of sensor signals being above a predetermined threshold.

Similarly, the term “sum signal” generally refers to a signal comprising essentially edge information of the beam profile. For example, the sum signal may be derived by adding up the sensor signals, integrating over the sensor signals or averaging over the sensor signals of the entire matrix or of a region of interest within the matrix, wherein the region of interest may be predetermined or determinable within an image generated by the optical sensors of the matrix. When adding up, integrating over or averaging over the sensor signals, the actual optical sensors from which the sensor signal is generated may be left out of the adding, integration or averaging or, alternatively, may be included into the adding, integration or averaging. The evaluation device may be adapted to determine the sum signal by integrating signals of the entire matrix, or of the region of interest within the matrix. For example, the beam profile may be a trapezoid beam profile and the evaluation device may be adapted to determine an integral of the entire trapezoid. Further, when trapezoid beam profiles may be assumed, the determination of edge and center signals may be replaced by equivalent evaluations making use of properties of the trapezoid beam profile such as determination of the slope and position of the edges and of the height of the central plateau and deriving edge and center signals by geometric considerations.

Similarly, the center signal and edge signal may also be determined by using segments of the beam profile such as circular segments of the beam profile. For example, the beam profile may be divided into two segments by a secant or a chord that does not pass the center of the beam profile. Thus, one segment will essentially contain edge information, while the other segment will contain essentially center information. For example, to further reduce the amount of edge information in the center signal, the edge signal may further be subtracted from the center signal.

The quotient Q may be a signal which is generated by combining the center signal and the sum signal. Specifically, the determining may include one or more of: forming a quotient of the center signal and the sum signal or vice versa; forming a quotient of a multiple of the center signal and a multiple of the sum signal or vice versa; forming a quotient of a linear combination of the center signal and a linear combination of the sum signal or vice versa. Additionally or alternatively, the quotient Q may comprise an arbitrary signal or signal combination which contains at least one item of information on a comparison between the center signal and the sum signal.

As used herein, the term “longitudinal coordinate for the reflection feature” refers to a distance between the optical sensor and the point of the scene remitting the corresponding illumination features. The evaluation device may be configured for using the at least one predetermined relationship between the quotient Q and the longitudinal coordinate for determining the longitudinal coordinate. The predetermined relationship may be one or more of an empiric relationship, a semi-empiric relationship and an analytically derived relationship. The evaluation device may comprise at least one data storage device for storing the predetermined relationship, such as a lookup list or a lookup table.

The evaluation device may be configured for executing at least one depth-from-photon-ratio algorithm which computes distances for all reflection features with zero order and higher order.

In a further aspect, the present invention discloses a method for material detection of at least one object, wherein a detector according to the present invention is used. The method comprises the following steps:
Illuminating the object with at least one illumination pattern generated by the at least one projector, wherein the illumination pattern comprises a plurality of illumination features, wherein the illumination pattern comprises a plurality of illumination features, wherein the illumination features have a first wavelength;
Illuminating the object with scene illumination generated by the at least one flood light source, wherein the flood light source is configured for emitting the scene illumination having a second wavelength different from the first wavelength;
Imaging at least one reflection image comprising a plurality of reflection features generated by the object in response to the illumination pattern using the sensor element, wherein each of the reflection features comprises a beam profile,
Imaging at least one scene image of the object illuminated by the scene illumination using the sensor element;
determining at least one first material information of the object by evaluating the beam profile of at least one of the reflection features using the evaluation device,
determining at least one second material information of the object by evaluating the scene image using the evaluation device,
determining the material of the object using the first material information and the second material information by using the evaluation device.

The method steps may be performed in the given order or may be performed in a different order. Further, one or more additional method steps may be present which are not listed. Further, one, more than one or even all of the method steps may be performed repeatedly. For details, options and definitions, reference may be made to the detector as discussed above. Thus, specifically, as outlined above, the method may comprise using the detector according to the present invention, such as according to one or more of the embodiments given above or given in further detail below.

The method further may comprise evaluating the sensor signals thereby determining a combined signal Q and determining a longitudinal coordinate of at least one of the reflection features by analysis of its respective beam profile. The analysis of a beam profile may comprise evaluating the combined signal Q from the sensor signals associated with the reflection feature. The evaluation device may be configured for using at least one predetermined relationship between the combined signal Q and the longitudinal coordinate for determining the longitudinal coordinate.

In a further aspect a computer program including computer-executable instructions for performing the method according to the present invention when the program is executed on a computer or computer network is disclosed.

In a further aspect of the present invention, use of the detector according to the present invention, such as according to one or more of the embodiments given above or given in further detail below, is proposed, for a purpose of use, selected from the group consisting of: a position measurement in traffic technology; an entertainment application; a security application; a surveillance application; a safety application; a human-machine interface application; a tracking application; a photography application; an imaging application or camera application; a mapping application for generating maps of at least one space; a homing or tracking beacon detector for vehicles; an outdoor application; a mobile application; a communication application; a machine vision application; a robotics application; a quality control application; a manufacturing application; automotive application.

For example, the detector may be used for automotive applications such as for driver monitoring, personalized vehicles and the like.

With respect to further uses of the detector and devices of the present invention reference is made to WO 2018/091649 A1, WO 2018/091638 A1, WO 2018/091640 A1 and C. Lennartz, F. Schick, S. Metz, “Whitepaper-Beam Profile Analysis for 3D imaging and material detection” Apr. 28, 2021, Ludwigshafen, Germany, the content of which is included by reference.

Overall, in the context of the present invention, the following embodiments are regarded as preferred:
Embodiment 1. A detector for material detection of at least one object, the detector comprising:
   at least one projector for illuminating at least one object with at least one illumination pattern, wherein the illumination pattern comprises a plurality of illumination features, wherein the illumination features have a first wavelength;
   at least one flood light source configured for scene illumination, wherein the flood light source is configured for emitting the scene illumination having a second wavelength different from the first wavelength;
   at least one sensor element having a matrix of optical sensors, the optical sensors each having a light-sensitive area, wherein each optical sensor is designed to generate at least one sensor signal in response to an illumination of its respective light-sensitive area by a light beam propagating from the object to the detector,
   wherein the sensor element is configured for imaging at least one reflection image comprising a plurality of reflection features generated by the object in response to the illumination pattern, wherein each of the reflection features comprises a beam profile, wherein the sensor element is configured for imaging at least one scene image of the object illuminated by the scene illumination;
   at least one evaluation device,
   wherein the evaluation device is configured for determining at least one first material information of the object by evaluating the beam profile of at least one of the reflection features,
   wherein the evaluation device is configured for determining at least one second material information of the object by evaluating the scene image,
   wherein the evaluation device is configured for determining the material of the object using the first material information and the second material information.
Embodiment 2. The detector according to the preceding embodiment, wherein the evaluation device is configured for using the second material information as an additional information channel for distinguishing between materials.
Embodiment 3. The detector according to any one of the preceding embodiments, wherein the detector is configured for distinguish between biological or non-biological material.
Embodiment 4. The detector according to any one of the preceding embodiments, wherein the detector is configured for distinguish between skin and non-skin objects.
Embodiment 5. The detector according to any one of the preceding embodiments, wherein the first wavelength and the second wavelength are different wavelength in the infrared spectral range.
Embodiment 6. The detector according to any one of the preceding embodiments, wherein the first wavelength is 940 nm and the second wavelength is 850 nm.
Embodiment 7. The detector according to any one of the preceding embodiments, wherein the projector comprises a plurality of emitters, wherein the emitters comprise at least one emitter selected from the group consisting of at least one semiconductor laser, at least one double heterostructure laser, at least one external cavity laser, at least one separate confinement heterostructure laser, at least one quantum cascade laser, at least one distributed bragg reflector laser, at least one polariton laser, at least one hybrid silicon laser, at least one extended cavity diode laser, at least one quantum dot laser, at least one volume Bragg grating laser, at least one Indium Arsenide laser, at least one transistor laser, at least one diode pumped laser, at least one distributed feedback laser, at least one quantum well laser, at least one interband cascade laser, at least one Gallium Arsenide laser, at least one semiconductor ring laser, at least one extended cavity diode laser, and at least one vertical cavity surface-emitting laser (VCSEL).
Embodiment 8. The detector according to any one of the preceding embodiments, wherein the flood light source comprises at least one light-emitting-diode (LED).
Embodiment 9. The detector according to any one of the preceding embodiments, wherein the evaluation device is configured for determining a longitudinal coordinate of at least one of the reflection features by analysis of its respective beam profile, wherein the analysis of a beam profile comprises evaluating a combined signal Q from the sensor signals associated with the reflection feature, wherein the evaluation device is configured for using at least one predetermined relationship between the combined signal Q and the longitudinal coordinate for determining the longitudinal coordinate.
Embodiment 10. The detector according to the preceding embodiment, wherein the evaluation device is configured for deriving the combined signal Q by one or more of dividing the sensor signals, dividing multiples of the sensor signals, dividing linear combinations of the sensor signals.
Embodiment 11. The detector according to any one of the preceding embodiments, wherein the sensor element comprises at least one CCD chip and/or at least one CMOS chip.
Embodiment 12. A method for material detection of at least one object, using at least one detector according to any one of the preceding embodiments, the method comprising the following steps:
   Illuminating the object with at least one illumination pattern generated by the at least one projector, wherein the illumination pattern comprises a plurality of illumination features, wherein the illumination pattern comprises a plurality of illumination features, wherein the illumination features have a first wavelength;
   Illuminating the object with scene illumination generated by the at least one flood light source, wherein the flood light source is configured for emitting the scene illumination having a second wavelength different from the first wavelength;
   Imaging at least one reflection image comprising a plurality of reflection features generated by the object in response to the illumination pattern using the sensor element, wherein each of the reflection features comprises a beam profile,
   Imaging at least one scene image of the object illuminated by the scene illumination using the sensor element;
   determining at least one first material information of the object by evaluating the beam profile of at least one of the reflection features using the evaluation device,
   determining at least one second material information of the object by evaluating the scene image using the evaluation device,
   determining the material of the object using the first material information and the second material information by using the evaluation device.
Embodiment 13. The method according to the preceding embodiment, wherein the method further comprises evaluating the sensor signals thereby determining a combined signal Q and determining a longitudinal coordinate of at least one of the reflection features by analysis of its respective beam profile, wherein the analysis of a beam profile comprises evaluating the combined signal Q from the sensor signals associated with the reflection feature, wherein the evaluation device is configured for using at least one predetermined relationship between the combined signal Q and the longitudinal coordinate for determining the longitudinal coordinate.
Embodiment 14. A use of the detector according to any one of the preceding embodiments referring to a detector, for a purpose of use, selected from the group consisting of: a position measurement in traffic technology; an entertainment application; a security application; a surveillance application; a safety application; a human-machine interface application; a tracking application; a photography application; an imaging application or camera application; a mapping application for generating maps of at least one space; a homing or tracking beacon detector for vehicles; an outdoor application; a mobile application; a communication application; a machine vision application; a robotics application; a quality control application; a manufacturing application; automotive application.

As used in the herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

### BRIEF DESCRIPTION OF THE FIGURES

Further optional details and features of the invention are evident from the description of preferred exemplary embodiments which follows in conjunction with the dependent claims. In this context, the particular features may be implemented in an isolated fashion or in combination with other features. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an embodiment of a detector according to the present invention;

FIG. 2 shows a mobile device comprising the detector;

FIG. 3 shows a reflectance distribution; and

FIG. 4 shows an embodiment of a method according to the present invention.

### DETAILED DESCRIPTION OF THE EMBODIMENTS

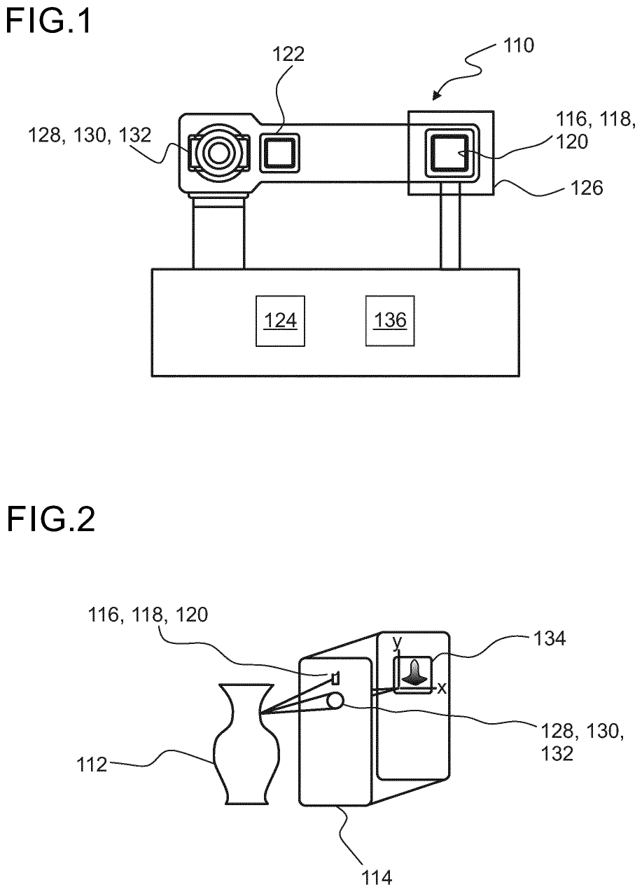

FIG. 1 shows in a highly schematic fashion an embodiment of a detector 110 for material detection of at least one object 112 according to the present invention. In FIG. 2 an exemplary object 112 is shown. As further shown in FIG. 2, the detector 110 may be one of attached to or integrated into a mobile device 114 such as a mobile phone or smartphone. The detector 110 may be integrated in a mobile device 114, e.g. within a housing of the mobile device 114. The mobile device 114 is one or more of a mobile communication device such as a cell phone or smartphone, a tablet computer, a portable computer.

The detector 110 comprises at least one projector 116 for illuminating the object 112 with at least one illumination pattern. The illumination pattern comprises a plurality of illumination features. The illumination features have a first wavelength.

The illumination pattern may be selected from the group consisting of: at least one point pattern; at least one line pattern; at least one stripe pattern; at least one checkerboard pattern; at least one pattern comprising an arrangement of periodic or non periodic features. The illumination pattern may comprise regular and/or constant and/or periodic pattern such as a triangular pattern, a rectangular pattern, a hexagonal pattern or a pattern comprising further convex tilings. The illumination pattern may exhibit the at least one illumination feature selected from the group consisting of: at least one point; at least one line; at least two lines such as parallel or crossing lines; at least one point and one line; at least one arrangement of periodic or non-periodic feature; at least one arbitrary shaped featured. The illumination pattern may comprise at least one pattern selected from the group consisting of: at least one point pattern, in particular a pseudorandom point pattern; a random point pattern or a quasi random pattern; at least one Sobol pattern; at least one quasiperiodic pattern; at least one pattern comprising at least one pre-known feature at least one regular pattern; at least one triangular pattern; at least one hexagonal pattern; at least one rectangular pattern at least one pattern comprising convex uniform tilings; at least one line pattern comprising at least one line; at least one line pattern comprising at least two lines such as parallel or crossing lines. For example, the projector 116 may be configured for generate and/or to project a cloud of points or non-point-like features. For example, the projector 116 may be configured for generate a cloud of points or non-point-like features such that the illumination pattern may comprise a plurality of point features or non-point-like features. The illumination pattern may comprise regular and/or constant and/or periodic patterns such as a triangular pattern, a rectangular pattern, a hexagonal pattern, or a pattern comprising further convex tilings. The illumination pattern may comprise as many features per area as possible such that a hexagonal pattern may be preferred. A distance between two features of the respective illumination pattern and/or an area of the at least one illumination feature may depend on a circle of confusion in an image determined by at least one detector. For example, illumination pattern may comprise a periodic point pattern.

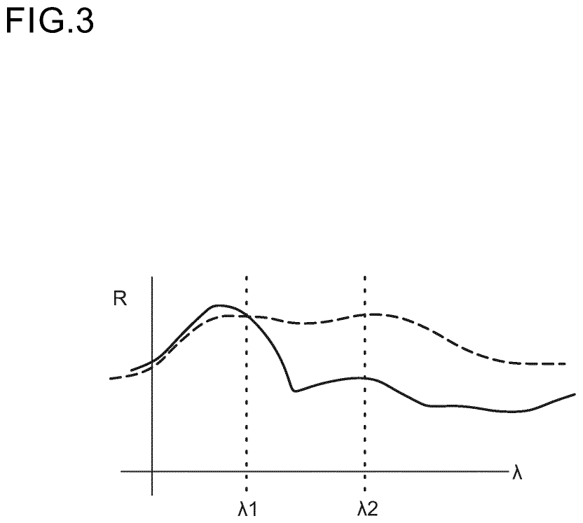

The projector 116 comprises the at least one array 118 of emitters 120, e.g. as shown in FIG. 3. Each of the emitters 120 is configured for generating at least one light beam. Each of the emitters 120 may be and/or may comprise at least one element selected from the group consisting of at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface-emitting laser (VCSEL), in particular at least one VCSEL-array; at least one non-laser light source such as at least one LED or at least one light bulb.

The array 118 of emitters 120 may be a two-dimensional or one dimensional array. The array 118 may comprise a plurality of emitters 120 arranged in a matrix. As shown in FIG. 3, the matrix specifically may be or may comprise a rectangular matrix having one or more rows and one or more columns. The rows and columns specifically may be arranged in a rectangular fashion. However, other arrangements are feasible, such as nonrectangular arrangements. As an example, circular arrangements are also feasible, wherein the elements are arranged in concentric circles or ellipses about a center point.

For example, the emitters 120 may be an array 118 of VCSELs. Examples for VCSELs can be found e.g. in en.wikipedia.org/wiki/Vertical-cavity_surface-emitting_laser. VCSELs are generally known to the skilled person such as from WO 2017/222618 A. Each of the VCSELs is configured for generating at least one light beam. The VCSELs may be arranged on a common substrate or on different substrates. The array 118 may comprise up to 2500 VCSELs. For example, the array 118 may comprise 38×25 VCSELs, such as a high power array with 3.5 W. For example, the array may comprise 10×27 VCSELs with 2.5 W. For example, the array may comprise 96 VCSELs with 0.9 W. A size of the array, e.g. of 2500 elements, may be up to 2 mm×2 mm.

The illumination features have a first wavelength. The light beam emitted by the respective emitter 120 may have a wavelength of 300 to 1100 nm, preferably 500 to 1100 nm. For example, light in the infrared spectral range may be used, such as in the range of 780 nm to 3.0 μm. Specifically, the light in the part of the near infrared region where silicon photodiodes are applicable specifically in the range of 700 nm to 1100 nm may be used. The emitters 120 may be configured for generating the at least one illumination pattern in the infrared region, in particular in the near infrared region. Using light in the near infrared region may allows that light is not or only weakly detected by human eyes and is still detectable by silicon sensors, in particular standard silicon sensors.

For example, the first wavelength may be 940 nm. This wavelength may be advantageous since terrestrial sun radiation has a local minimum in irradiance at this wavelength, e.g. as described in CIE 085-1989 “Solar spectral Irradiance”. For example, the emitters 120 may be an array of VCSELs. The VCSELs may be configured for emitting light beams at a wavelength range from 800 to 1000 nm. For example, the VCSELs may be configured for emitting light beams at 808 nm, 850 nm, 940 nm, or 980 nm. Preferably the VCSELs emit light at 940 nm.

The detector comprises at least one flood light source 122 configured for scene illumination. The flood light source 122 is configured for emitting the scene illumination having a second wavelength different from the first wavelength. The flood light source 122 may be adapted to provide the at least one illumination light beam for illumination of the object. The flood light source 122 is configured for scene illumination. The scene illumination may be diffuse and/or uniform illumination of the scene. The scene may comprise the at least one object 112 and a surrounding environment. The flood light source 122 may be adapted to directly or indirectly illuminating the object 112, wherein the illumination is reflected or scattered by surfaces of the object 112 and, thereby, is at least partially directed towards a sensor element of the detector 110. The flood light source 122 may be adapted to illuminate the object 112, for example, by directing a light beam towards the object 112, which reflects the light beam.

The flood light source 122 is configured for emitting the scene illumination having a second wavelength different from the first wavelength. The flood light source 122 may comprise at least one light-emitting-diode (LED). The flood light source 122 may comprise a single light source or a plurality of light sources. As an example, the light emitted by the flood light source 122 may have a wavelength of 300 to 1100 nm, especially 500 to 1100 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1100 nm may be used. The flood light source 122 may be configured for emitting light at a single wavelength. Specifically, the wavelength may be in the near infrared region. In other embodiments, the flood light source 122 may be adapted to emit light with a plurality of wavelengths allowing additional measurements in other wavelengths channels.

The first and the second wavelength may be chosen such that it possible for distinguishing materials. For example, two or more materials may have a similar reflectance for the first wavelength but their respective reflectance for the second wavelength may be different. The first wavelength and the second wavelength may be different wavelength in the infrared spectral range. For example, the first wavelength may be 940 nm and the second wavelength may be 850 nm.

The detector 110 may comprise at least one control unit 124 configured for controlling light emission of the projector 116 and/or the flood light source 122. For example, the projector 116 comprises at least one shutter 126. The shutter 126 may be an optical element configured for blocking light to pass. The shutter 126 may be configured for temporally blocking light from one of the emitters 120 to pass.

The detector 110 at least one sensor element 128, e.g. being part of at least one camera 130, having having a matrix of optical sensors 132. The optical sensors 132 each having a light-sensitive area. Each optical sensor 132 is designed to generate at least one sensor signal in response to an illumination of its respective light-sensitive area by a reflection light beam propagating from the object 112 to the sensor element 128. The sensor element 128 may be or may comprise at least one imaging element configured for recording or capturing spatially resolved one-dimensional, two-dimensional or even three-dimensional optical data or information. As an example, the sensor element 128 may comprise at least one camera chip, such as at least one CCD chip and/or at least one CMOS chip configured for recording images.

The optical sensor 132 specifically may be or may comprise at least one photodetector, preferably inorganic photodetectors, more preferably inorganic semiconductor photodetectors, most preferably silicon photodetectors. Specifically, the optical sensor 132 may be sensitive in the infrared spectral range. All pixels of the matrix or at least a group of the optical sensors of the matrix specifically may be identical. Groups of identical pixels of the matrix specifically may be provided for different spectral ranges, or all pixels may be identical in terms of spectral sensitivity. Further, the pixels may be identical in size and/or with regard to their electronic or optoelectronic properties. Specifically, the optical sensor 132 may be or may comprise at least one inorganic photodiode which are sensitive in the infrared spectral range, preferably in the range of 700 nm to 3.0 micrometers. Specifically, the optical sensor 132 may be sensitive in the part of the near infrared region where silicon photodiodes are applicable specifically in the range of 700 nm to 1100 nm. Infrared optical sensors which may be used for optical sensors may be commercially available infrared optical sensors, such as infrared optical sensors commercially available under the brand name Hertzstueck™ from trinamiX™ GmbH, D-67056 Ludwigshafen am Rhein, Germany. Thus, as an example, the optical sensor 132 may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensor 132 may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensor 132 may comprise at least one photoconductive sensor such as a PbS or PbSe sensor, a bolometer, preferably a bolometer selected from the group consisting of a VO bolometer and an amorphous Si bolometer.

The optical sensor 132 may be sensitive in one or more of the ultraviolet, the visible or the infrared spectral range. Specifically, the optical sensor may be sensitive in the visible spectral range from 500 nm to 780 nm, most preferably at 650 nm to 750 nm or at 690 nm to 700 nm. Specifically, the optical sensor 132 may be sensitive in the near infrared region. Specifically, the optical sensor 132 may be sensitive in the part of the near infrared region where silicon photodiodes are applicable specifically in the range of 700 nm to 1000 nm. The optical sensor 132, specifically, may be sensitive in the infrared spectral range, specifically in the range of 780 nm to 3.0 micrometers. For example, the optical sensor each, independently, may be or may comprise at least one element selected from the group consisting of a photodiode, a photocell, a photoconductor, a phototransistor or any combination thereof. For example, the optical sensor 132 may be or may comprise at least one element selected from the group consisting of a CCD sensor element, a CMOS sensor element, a photodiode, a photocell, a photoconductor, a phototransistor or any combination thereof. Any other type of photosensitive element may be used. The photosensitive element generally may fully or partially be made of inorganic materials and/or may fully or partially be made of organic materials. Most commonly, one or more photodiodes may be used, such as commercially available photodiodes, e.g. inorganic semiconductor photodiodes.

The sensor element 128 comprises a matrix of pixels. Thus, as an example, the optical sensor 132 may be part of or constitute a pixelated optical device. For example, the optical sensor 132 may be and/or may comprise at least one CCD and/or CMOS device. As an example, the optical sensor 132 may be part of or constitute at least one CCD and/or CMOS device having a matrix of pixels, each pixel forming a light-sensitive area. The sensor element may be formed as a unitary, single device or as a combination of several devices. The matrix specifically may be or may comprise a rectangular matrix having one or more rows and one or more columns. The rows and columns specifically may be arranged in a rectangular fashion. However, other arrangements are feasible, such as nonrectangular arrangements. As an example, circular arrangements are also feasible, wherein the elements are arranged in concentric circles or ellipses about a center point. For example, the matrix may be a single row of pixels. Other arrangements are feasible.

The pixels of the matrix specifically may be equal in one or more of size, sensitivity and other optical, electrical and mechanical properties. The light-sensitive areas of all optical sensors 132 of the matrix specifically may be located in a common plane, the common plane preferably facing the scene, such that a light beam propagating from the object 112 to the detector 110 may generate a light spot on the common plane. The light-sensitive area may specifically be located on a surface of the respective optical sensor 132. Other embodiments, however, are feasible. The sensor element 128 may comprise for example, at least one CCD and/or CMOS device. As an example, the sensor element 128 may be part of or constitute a pixelated optical device. As an example, the optical sensor 132 may be part of or constitute at least one CCD and/or CMOS device having a matrix of pixels, each pixel forming a light-sensitive area.

The sensor element 128 is configured for imaging at least one scene image of the object 112 illuminated by the scene illumination. The scene image may be generated in response to the diffuse and/or uniform illumination of the object 112 by the scene illumination. The scene image may not comprise any reflection features generated by the illumination pattern. The scene image may be at least one two-dimensional image.

The sensor element 128 is configured for imaging at least one reflection image comprising a plurality of reflection features generated by the object 112 in response to the illumination pattern. The reflection feature may be a feature in an image plane generated by the scene in response to illumination, specifically with at least one illumination feature. Each of the reflection features comprises at least one beam profile 134, also denoted reflection beam profile, see exemplarily in FIG. 2. The beam profile 134 of the reflection feature may generally refer to at least one intensity distribution of the reflection feature, such as of a light spot on the optical sensor 132, as a function of the pixel. The beam profile 134 may be selected from the group consisting of a trapezoid beam profile; a triangle beam profile; a conical beam profile and a linear combination of Gaussian beam profiles.

The detector 110 comprises at least one evaluation device 136. The evaluation device 136 is configured for determining at least one first material information of the object by evaluating the beam profile 134 of at least one of the reflection features.

The evaluation device 136 may be configured for evaluating the reflection image. The evaluation of the reflection image may comprise identifying the reflection features of the reflection image. The evaluation device 136 may be configured for performing at least one image analysis and/or image processing in order to identify the reflection features. The image analysis and/or image processing may use at least one feature detection algorithm. The image analysis and/or image processing may comprise one or more of the following: a filtering; a selection of at least one region of interest; a formation of a difference image between an image created by the sensor signals and at least one offset; an inversion of sensor signals by inverting an image created by the sensor signals; a formation of a difference image between an image created by the sensor signals at different times; a background correction; a decomposition into color channels; a decomposition into hue; saturation; and brightness channels; a frequency decomposition; a singular value decomposition; applying a blob detector; applying a corner detector; applying a Determinant of Hessian filter; applying a principle curvature-based region detector; applying a maximally stable extremal regions detector; applying a generalized Hough-transformation; applying a ridge detector; applying an affine invariant feature detector; applying an affine-adapted interest point operator; applying a Harris affine region detector; applying a Hessian affine region detector; applying a scale-invariant feature transform; applying a scale-space extrema detector; applying a local feature detector; applying speeded up robust features algorithm; applying a gradient location and orientation histogram algorithm; applying a histogram of oriented gradients descriptor; applying a Deriche edge detector; applying a differential edge detector; applying a spatio-temporal interest point detector; applying a Moravec corner detector; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wavelet-transformation; a thresholding; creating a binary image. The region of interest may be determined manually by a user or may be determined automatically, such as by recognizing a feature within the image generated by the optical sensor.

The evaluation device 136 may be configured for determining the beam profile 134 of the respective reflection feature. The determining the beam profile 134 may comprise identifying at least one reflection feature provided by the optical sensor 132 and/or selecting at least one reflection feature provided by the optical sensor 132 and evaluating at least one intensity distribution of the reflection feature. As an example, a region of the matrix may be used and evaluated for determining the intensity distribution, such as a three-dimensional intensity distribution or a two-dimensional intensity distribution, such as along an axis or line through the matrix. As an example, a center of illumination by the light beam may be determined, such as by determining the at least one pixel having the highest illumination, and a cross-sectional axis may be chosen through the center of illumination. The intensity distribution may an intensity distribution as a function of a coordinate along this cross-sectional axis through the center of illumination. Other evaluation algorithms are feasible.

The evaluation device 136 is configured for determining the at least one first material information of the object by evaluating the beam profile 134 of at least one of the reflection features. The evaluation device 136 may be configured for determining the at least one first material information of the object 112 by evaluating the beam profile 134 of at least three or more of the reflection features, in particular of all of the reflection features.

The evaluation device 136 may be configured for identifying a reflection feature as to be generated by an item having a specific material property in case its reflection beam profile fulfills at least one predetermined or predefined criterion. The at least one predetermined or predefined criterion may be at least one property and/or value suitable to distinguish material properties. The predetermined or predefined criterion may be or may comprise at least one predetermined or predefined value and/or threshold and/or threshold range referring to a material property. The reflection feature may be indicated as to be generated by an item having a specific material property in case the reflection beam profile fulfills the at least one predetermined or predefined criterion. The indication may comprise an arbitrary indication such as an electronic signal and/or at least one visual or acoustic indication, e.g. via a display of the mobile device 114.

The determining at least one material information may comprise assigning at least one material property to a respective reflection feature. The evaluation device 136 may comprise at least one database comprising a list and/or table, such as a lookup list or a lookup table, of predefined and/or predetermined material properties. The list and/or table of material properties may be determined and/or generated by performing at least one test measurement, for example by performing material tests using samples having known material properties. The list and/or table of material properties may be determined and/or generated at the manufacturer site and/or by a user. The material property may additionally be assigned to a material classifier such as one or more of a material name, a material group such as biological or non-biological material, translucent or non-translucent materials, metal or non-metal, fur or non-fur, carpet or non-carpet, reflective or non-reflective, specular reflective or non-specular reflective, foam or non-foam, roughness groups or the like. The evaluation device 136 may comprise at least one database comprising a list and/or table comprising the material properties and associated material name and/or material group.

For determining the first material information, beam profile analysis may be used. Specifically, beam profile analysis makes use of reflection properties of coherent light projected onto object surfaces to classify materials. The classification of materials may be performed as described in WO 2020/187719, in EP application No. 20159984.2 filed on Feb. 28, 2020 and/or EP application 20 154 961.5 filed on Jan. 31, 2020, and C. Lennartz, F. Schick, S. Metz, “Whitepaper—Beam Profile Analysis for 3D imaging and material detection” Apr. 28, 2021, Ludwigshafen, Germany, the full content of which is included by reference. Specifically, a periodic grid of laser spots, e.g. a hexagonal grid as described in EP application 20 170 905.2 filed on Apr. 22, 2020, is projected and the reflection image is recorded with the camera. Analyzing the beam profile of each reflection feature recorded by the sensor element may be performed by feature-based methods and/or using based on a convolutional neural network classifying the reflection features of the reflection image. The feature based methods may be used in combination with machine learning methods which may allow parametrization of a classification model. Convolutional neuronal networks may be utilized to classify materials by using the reflection images as an input.

The evaluation device 136 is configured for determining at least one second material information of the object by evaluating the scene image. The evaluating of the scene image may comprise determining at least one reflectance value of at least one region of interest. The region of interest may be selected manually by a user and/or automatically by using at least one object detection algorithm. The evaluating may comprise comparing the reflectance value to at least one predetermined or predefined value and/or threshold and/or threshold range referring to a material property.

The determination of the second material information may be performed using at least one parametrized classification model. The parametrized model may be a combined parametrized classification model for determining the first material information and the second material information and/or at least one further parametrized classification model, in particular in addition to the parametrized model used for determining the first material information. The combined parametrized classification model and/or the further parametrized classification model may be at least partially data-driven. For example, the combined parametrized classification model and/or the further parametrized classification model may be based on experimental data. For example, the training may comprise using at least one training dataset, wherein the training data set comprises images, in particular scene images of a plurality of items with known material property for the further parametrized model and/or scene images and reflection images for the combined parametrized classification model.

The determination of the second material information may be performed sequentially or simultaneously to the determination of the first material information. The at least second material information may be used separately and/or together with the first material information. The evaluation of the scene image can be performed sequentially or simultaneously to the evaluation of the reflection image using the at least one parametrized classification model. The evaluation device 136 may be configured for determining a final material classification. The final material classification may be the combination of the results of the at parametrized classification model(s) using the first and second material information.

For example, the evaluation device 136 may be configured for sequentially using the first material information and at least one parametrized classification model providing at least one material confidence for deciding whether the at least one second material information needs to be evaluated. For example, if skin or non-skin must be classified and the first material information rejects skin with high confidence, the second material information might be not necessary for the final classification decision. The decision, if the second material information is used, may be evaluated using the at least one parametrized classification model.

For example, the evaluation may be performed simultaneously, e.g. using the combined parametrized classification model.

The evaluation device 136 may be configured for determining a combination of the results of the parametrized classification model(s) using the first and second material information. The combination of the first and second material information may allow material classification with enhanced confidence.

The first material information may be a material property characterizing the material of the object. The evaluation device 136 may be configured for using the second material information as an additional information channel for distinguishing between materials, e.g. in case of ambiguities. Using an additional information channel may be advantageous in case of difficult targets such as distinguishing skin and silicon. The detector 110 may be configured for distinguish between biological or non-biological material. The detector 110 may be configured for distinguish between skin and non-skin objects.

The evaluation device 136 is configured for determining the material of the object using the first material information and the second material information. The evaluation device 136 may be configured for determining the material of the object 112 by using the first material information only. This may be suitable for many materials. However, in case of different targets, i.e. targets having similar reflectance values at the first wavelength, the second material information may be considered by the evaluation device 136 for distinguishing between the materials. This may significantly increase reliability of material detection and, thus, increases likelihood of identifying spoofing attacks.

The evaluation device 136 is configured for determining a longitudinal coordinate of at least one of the reflection features by analysis of its respective beam profile. The evaluation device 136 may be configured for determining at least one longitudinal coordinate z_{DPR} for each of the reflection features by analysis of the beam profile of the respective reflection feature. The evaluation device 136 may be configured for determining the longitudinal coordinate z_{DPR} for the reflection features by using the so called depth-from-photon-ratio technique, also denoted as beam profile analysis. With respect to depth-from-photon-ratio (DPR) technique reference is made to WO 2018/091649 A1, WO 2018/091638 A1 and WO 2018/091640 A1 and C. Lennartz, F. Schick, S. Metz, “Whitepaper-Beam Profile Analysis for 3D imaging and material detection” Apr. 28, 2021, Ludwigshafen, Germany, the full content of which is included by reference.

FIG. 3 shows a distribution of reflectance R as a function of the wavelength λ. The first and second wavelengths are indicated as λ1 and λ2, respectively. The distribution is shown for two different materials, indicated as dotted and solid lines. FIG. 3 shows that even if the two materials have a similar value at the first wavelength λ1, they are clearly distinguishable using the second wavelength λ2.

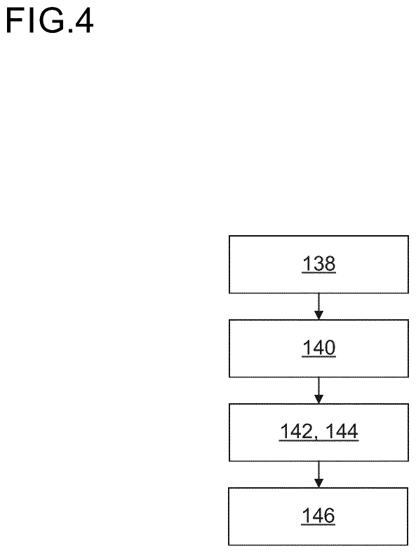

FIG. 4 shows an embodiment of a method for material detection according to the present invention, wherein a detector 110 according to the present invention is used. The method comprises the following steps:
(denoted with reference number 138) Illuminating the object 112 with at least one illumination pattern generated by the at least one projector 116, wherein the illumination pattern comprises a plurality of illumination features, wherein the illumination pattern comprises a plurality of illumination features, wherein the illumination features have a first wavelength, and imaging at least one reflection image comprising a plurality of reflection features generated by the object 112 in response to the illumination pattern using the sensor element 128, wherein each of the reflection features comprises a beam profile 134;
(denoted with reference number 140) Illuminating the object 112 with scene illumination generated by the at least one flood light source 122, wherein the flood light source 122 is configured for emitting the scene illumination having a second wavelength different from the first wavelength and imaging at least one scene image of the object illuminated by the scene illumination using the sensor element 128;
(denoted with reference number 142) determining at least one first material information of the object by evaluating the beam profile 134 of at least one of the reflection features using the evaluation device 136,
(denoted with reference number 144) determining at least one second material information of the object 112 by evaluating the scene image using the evaluation device 136,
(denoted with reference number 146) determining the material of the object 112 using the first material information and the second material information by using the evaluation device 136.

The method steps may be performed in the given order or may be performed in a different order. Further, one or more additional method steps may be present which are not listed. Further, one, more than one or even all of the method steps may be performed repeatedly. For details, options and definitions, reference may be made to the detector 110 as described with respect to FIGS. 1 and 2.

### LIST OF REFERENCE NUMBERS

110 detector
112 object
114 mobile device
116 projector
118 array
120 emitter
122 flood light source
124 control unit
126 shutter
128 sensor element
130 camera
132 optical sensor
134 beam profile
136 evaluation device
138 Illuminating with at least one illumination pattern and imaging at least one reflection image
140 Illuminating with scene illumination and imaging at least one scene image
142 determining at least one first material information o
144 determining at least one second material information
146 determining the material of the object

1. A detector for material detection of at least one object, the detector comprising:
at least one projector for illuminating at least one object with at least one illumination pattern, wherein the illumination pattern comprises a plurality of illumination features, wherein each of the illumination features is at least one at least partially extended feature of the illumination pattern, wherein the illumination features have a first wavelength;
at least one flood light source configured for scene illumination, wherein the flood light source is configured for emitting the scene illumination having a second wavelength different from the first wavelength;
at least one sensor element having a matrix of optical sensors, the optical sensors each having a light-sensitive area, wherein each optical sensor is designed to generate at least one sensor signal in response to an illumination of its respective light-sensitive area by a light beam propagating from the object to the detector,
wherein the sensor element is configured for imaging at least one reflection image comprising a plurality of reflection features generated by the object in response to the illumination pattern, wherein a reflection feature is a feature in an image plane generated by the object in response to illumination with at least one illumination feature, wherein each of the reflection features comprises a beam profile,
wherein the sensor element is configured for imaging at least one scene image of the object illuminated by the scene illumination;
at least one evaluation device,
wherein the evaluation device is configured for determining at least one first material information of the object by evaluating the beam profile of at least one of the reflection features,
wherein the evaluation device is configured for determining at least one second material information of the object by evaluating the scene image,
wherein the evaluation device is configured for determining the material of the object using the first material information and the second material information.

2. The detector according to claim 1, wherein the evaluation device is configured for using the second material information as an additional information channel for distinguishing between materials.

3. The detector according to claim 1, wherein the detector is configured to distinguish between biological or non-biological material.

4. The detector according to claim 1, wherein the detector is configured to distinguish between skin and non-skin objects.

5. The detector according to claim 1, wherein the first wavelength and the second wavelength are different wavelengths in the infrared spectral range.

6. The detector according to claim 1, wherein the first wavelength is 940 nm and the second wavelength is 850 nm.

7. The detector according to claim 1, wherein the projector comprises a plurality of emitters, wherein the emitters comprise at least one emitter selected from the group consisting of at least one semiconductor laser, at least one double heterostructure laser, at least one external cavity laser, at least one separate confinement heterostructure laser, at least one quantum cascade laser, at least one distributed bragg reflector laser, at least one polariton laser, at least one hybrid silicon laser, at least one extended cavity diode laser, at least one quantum dot laser, at least one volume Bragg grating laser, at least one Indium Arsenide laser, at least one transistor laser, at least one diode pumped laser, at least one distributed feedback laser, at least one quantum well laser, at least one interband cascade laser, at least one Gallium Arsenide laser, at least one semiconductor ring laser, at least one extended cavity diode laser, and at least one vertical cavity surface-emitting laser (VCSEL).

8. The detector claim 1, wherein the flood light source comprises at least one light-emitting-diode (LED).

9. The detector according to claim 1, wherein the evaluation device is configured for determining a longitudinal coordinate of at least one of the reflection features by analysis of its respective beam profile, wherein the analysis of a beam profile comprises evaluating a combined signal Q from the sensor signals associated with the reflection feature, wherein the evaluation device is configured for using at least one predetermined relationship between the combined signal Q and the longitudinal coordinate for determining the longitudinal coordinate.

10. The detector according to claim 9, wherein the evaluation device is configured for deriving the combined signal Q by one or more of dividing the sensor signals, dividing multiples of the sensor signals, dividing linear combinations of the sensor signals.

11. The detector according to claim 1, wherein the sensor element comprises at least one CCD chip and/or at least one CMOS chip.

12. A method for material detection of at least one object, using at least one detector according to claim 1, the method comprising the following steps:
illuminating the object with at least one illumination pattern generated by the at least one projector, wherein the illumination pattern comprises a plurality of illumination features, wherein the illumination pattern comprises a plurality of illumination features, wherein each of the illumination features is at least one at least partially extended feature of the illumination pattern, wherein the illumination features have a first wavelength;
illuminating the object with scene illumination generated by the at least one flood light source, wherein the flood light source is configured for emitting the scene illumination having a second wavelength different from the first wavelength;
imaging at least one reflection image comprising a plurality of reflection features generated by the object in response to the illumination pattern using the sensor element, wherein a reflection feature is a feature in an image plane generated by the object in response to illumination with at least one illumination feature, wherein each of the reflection features comprises a beam profile,
imaging at least one scene image of the object illuminated by the scene illumination using the sensor element;
determining at least one first material information of the object by evaluating the beam profile of at least one of the reflection features using the evaluation device,
determining at least one second material information of the object by evaluating the scene image using the evaluation device, and
determining the material of the object using the first material information and the second material information by using the evaluation device.

13. The method according to claim 12, wherein the method further comprises evaluating the sensor signals thereby determining a combined signal Q and determining a longitudinal coordinate of at least one of the reflection features by analysis of its respective beam profile, wherein the analysis of a beam profile comprises evaluating the combined signal Q from the sensor signals associated with the reflection feature, wherein the evaluation device is configured for using at least one predetermined relationship between the combined signal Q and the longitudinal coordinate for determining the longitudinal coordinate.

14. A method of using the detector according to claim 1, the method comprising using the detector for a purpose, selected from the group consisting of a position measurement in traffic technology; an entertainment application; a security application; a surveillance application; a safety application; a human-machine interface application; a tracking application; a photography application; an imaging application or camera application; a mapping application for generating maps of at least one space; a homing or tracking beacon detector for vehicles; an outdoor application; a mobile application; a communication application; a machine vision application; a robotics application; a quality control application; a manufacturing application; and automotive application.
